(19) United States
(12) Patent Application Publication
(10) Pub. No.: US 2014/0092128 A1
(43) Pub. Date: Apr. 3, 2014

(54) IMAGE PROCESSING APPARATUS, IMAGE PROCESSING METHOD, AND PROGRAM

(71) Applicant: Sony Corporation, Tokyo (JP)

(72) Inventor: Sensaburo NAKAMURA, Kanagawa (JP)

(73) Assignee: Sony Corporation, Tokyo (JP)

(21) Appl. No.: 14/039,039

(22) Filed: Sep. 27, 2013

(30) Foreign Application Priority Data
Oct. 3, 2012 (JP) 2012-221740

(51) Int. Cl. G09G 5/377

(52) U.S. Cl. CPC G09G 5/377
USPC 345/629

(57) ABSTRACT

There is provided an image processing apparatus including an image generating unit that generates an image by performing image combining by computer graphics, on the basis of complex data to be description data of a virtual space by the computer graphics and having a plurality of static statuses of the virtual space, a video output unit that outputs the generated image as a video signal, and a control unit that causes the image generating unit to perform the image combining while performing transition according to a progress rate from a first static status to a second static status, on the basis of an instruction of transition from the first static status to the second static status in the complex data.

### BACKGROUND

The present disclosure relates to an image processing apparatus, an image processing method, and a program and more particularly, to an image processing apparatus that changes an image generated by computer graphics (CG) and obtains a moving image of a high added value according to a situation.

A method of handling a timeline execution scheme at the time of status transition, in which both editing of a status transition diagram and editing of a timeline are enabled, has been described in Japanese Patent Application Laid-Open (JP-A) No. 2007-183737.

### SUMMARY

According to technology that is described in Japanese Patent Application Laid-Open (JP-A) No. 2007-183737, it is necessary to set information as the timeline. Meanwhile, a method of changing a generated CG image with an action according to a manipulation intention is not realized.

It is desirable to enable a generated CG image to be changed with an action according to a manipulation intention.

According to an embodiment of the present technology, there is provided an image processing apparatus including an image generating unit that generates an image by performing image combining by computer graphics, on the basis of complex data to be description data of a virtual space by the computer graphics and having a plurality of static statuses of the virtual space, a video output unit that outputs the generated image as a video signal, and a control unit that causes the image generating unit to perform the image combining while performing transition according to a progress rate from a first static status to a second static status, on the basis of an instruction of transition from the first static status to the second static status in the complex data.

In the present disclosure, the image is generated by performing the image combining by computer graphics (CG), by the image generating unit. The image is generated on the basis of the complex data to be the description data of the virtual space by the computer graphics and having the plurality of static statuses of the virtual space. The generated image is output as the video signal by the video output unit. For example, the complex data may have a plurality of statuses for each of groups obtained by dividing parameters of the virtual space.

The image generating unit is controlled by the control unit. The control unit controls the image generating unit such that the image combining is performed while the transition is performed according to the progress rate from the first static status to the second static status. The control is performed on the basis of the instruction of the transition from the first static status to the second static status in the complex data. For example, the transition instruction may be based on a control signal from the outside.

For example, the control unit may change values of parameters forming the statuses of the virtual space, according to the progress rate, for each synchronization signal supplied from the outside. The control unit may change the progress rate according to an elapsed time from a start of the instruction of the transition. The control unit may change the progress rate according to a fader value from a fader.

As such, in the present disclosure, the image combining is performed by the CG while the transition is performed according to the progress rate from the first static status to the second static status, on the basis of the instruction of the transition from the first static status to the second static status in the complex data having the plurality of static statuses of the virtual space. For this reason, a generated CG image can be changed with an action according to a manipulation intention.

According to an embodiment of the present technology, the image generating unit may generate the image by performing the image combining by the computer graphics, on the basis of the complex data to be the description data of the virtual space by the computer graphics and having a graph structure in which the plurality of static statuses of the virtual space are arranged on nodes of the graph structure and the nodes are connected by sides of the graph structure, and the control unit may cause the image generating unit to perform the image combining while performing the transition according to the progress rate from the first static status to the second static status, on the basis of the instruction of the transition from the first static status to the second static status connected by the sides in the complex data.

For example, a data structure in which lengths of times are held in the sides of the complex data of the graph structure may be configured and the control unit may use the lengths of the times of the sides, when the transition of the sides is executed. For example, a data structure that holds the lengths of the times in the sides of the complex data of the graph structure may be configured and the control unit may use the lengths of the times of the sides, when the transition of the sides is executed.

In the present disclosure, the image processing apparatus may further include an effect switcher, a selection manipulation unit that receives a manipulation for selecting inputs signal supplied to a bus in the effect switcher from a plurality of choices and transmits a control signal to the effect switcher, and an allocating unit that sets content of each choice of the selection manipulation unit, the video signal output from the video output unit may be one of the input signals of the effect switcher, and the allocating unit may transmit a transition destination instruction to the control unit, in addition to the setting of the content of each choice of the selection manipulation unit. In this case, a transition trigger manipulation unit that manipulates the transition by a wipe function of the effect switcher may be made to function as a manipulation unit to generate a trigger to start the transition of the image generating unit and the progress rate of the transition may be manipulated by a fader lever.

In the present disclosure, the image processing apparatus may further include a preview image generating unit that generates an image for preview by performing the image combining by the computer graphics and a preview video output unit that outputs the generated image for preview as a video signal, the effect switcher may have a preview system that outputs a video signal scheduled for a next effect switcher output, and the effect switcher may generate an image at the time of transition completion by the preview image generating unit, according to a transition manipulation of the selection manipulation unit, output the video signal of the image for preview from the preview video output unit, and output the video signal from the preview system of the effect switcher.

According to embodiments of the present disclosure, a generated CG image can be changed with an action according to a manipulation intention.

### BRIEF DESCRIPTION OF THE DRAWINGS

FIG. 1 is a block diagram illustrating a configuration example of an image generating apparatus according to a first embodiment of the present disclosure;

FIG. 2 is a diagram illustrating the concept of complex data;

FIG. 3 is a diagram illustrating a set of statuses corresponding to CG complex data and a transition example thereof;

FIG. 4 is a flowchart illustrating control to receive a transition destination instruction, receive frame synchronization (VD synchronization), and perform a CG animation output;

FIG. 5 is a diagram illustrating a GUI of an editing unit;

FIG. 6 is a flowchart illustrating a status set generation function of an editing unit;

FIG. 7 is a flowchart illustrating an automatic extraction type status set generation function of an editing unit;

FIG. 8 is a diagram illustrating a structure and a concept of group configuration CG complex data;

FIG. 9 is a diagram illustrating an example of a GUI for manipulating for each group with respect to the same CG data from which a status set generation function is read;

FIG. 10 is a flowchart illustrating a status set generation function of an editing unit;

FIG. 11 is a flowchart illustrating an automatic extraction type status set generation function of an editing unit;

FIG. 12 is a diagram illustrating execution of a status destination instruction and a trigger using a control signal from the outside;

FIG. 13 is a block diagram illustrating a configuration example of an image processing apparatus according to a second embodiment of the present disclosure;

FIG. 14 is a diagram illustrating a configuration example of an M/E bank;

FIG. 15 is a diagram illustrating a graph structure according to an example of complex data;

FIG. 16 is a diagram illustrating an example of a GUI regarding a status instruction;

FIG. 17 is a diagram illustrating an example of an outer appearance (manipulation surface) of a switcher console;

FIG. 18 is a diagram illustrating a (lighting) status in the case in which a manipulator operates a CG button for a change from Mix in a switcher console;

FIG. 19 is a diagram illustrating the case in which a signal from an image generating unit is taken in a key signal;

FIG. 20 is a diagram illustrating a display example of the case of a configuration in which a transition destination instruction is performed by a manipulation of a cross point column;

FIG. 21 is a diagram illustrating a display example in the case in which a transition destination instruction is manipulated and input by a key1 column;

FIG. 22 is a diagram illustrating an Aux console to designate a manipulation target column by a Delegation button, manipulate a cross point button, and select any one signal;

FIG. 23 is a diagram illustrating a console of an M/E bank provided with an Util button;

FIG. 24 is a diagram illustrating a console of an M/E bank provided with an Util button;

FIG. 25 is a diagram illustrating a configuration according to another example of complex data;

FIG. 26 is a diagram illustrating a configuration in which a status change is progressed by linear interpolation of parameters during transition between statuses;

FIG. 27 is a diagram illustrating a configuration in which content of a change in the middle is designated during transition between statuses;

FIG. 28 is a diagram illustrating a configuration example of complex data of a valid graph structure;

FIG. 29 is a diagram illustrating a timeline having a length in a time unit, not %;

FIG. 30 is a diagram illustrating a GUI of a function of editing a timeline at the time of transition between statuses;

FIG. 31 is a diagram illustrating a function displayed on a GUI as a status transition diagram with respect to an entire situation of a stored timeline;

FIG. 32 is a diagram illustrating when a file of a CG timeline/animation is stored in a directory;

FIG. 33 is a diagram illustrating a system configuration in which a circuit block of a preview system is provided;

FIG. 34 is a diagram illustrating a system configuration in which a circuit block of a preview system is provided;

FIG. 35 is a diagram illustrating a group designation manipulation unit;

FIG. 36 is a block diagram illustrating a configuration example of an image processing apparatus in the case in which an M/E bank of an effect switcher and an image generating unit are connected without using a cross point; and

FIG. 37 is a diagram illustrating a configuration example of a console that can manipulate groups in parallel.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description will be made in the order described below.

### 1. First Embodiment

### 2. Second Embodiment

### 3. Modifications

### 1. First Embodiment

### [Configuration of Image Processing Apparatus]

FIG. 1 illustrates a configuration example of an image processing apparatus 100 according to a first embodiment of the present disclosure. The image processing apparatus 100 includes a control unit 110, an editing unit 120, a data holding unit 130, an image generating unit 140, a video output unit 150, a progress rate control unit 160, a transition destination instructing unit 170, and an interface unit 180.

The editing unit 120 generates complex data that is description data of a virtual space by computer graphics (CG) and has a plurality of static information of the virtual space. The data holding unit 130 holds the complex data is edited by the editing unit 120. The image generating unit 140 generates an image by performing image combining by the CG on the basis of the complex data held in the data holding unit 130.

The video output unit 150 outputs the image generated by the image generating unit 140 as a video signal, for example, an SDI signal. The image generating unit 140 and the video output unit 150 operate in synchronization with an external synchronization signal. The video output unit 150 outputs the video signal in synchronization with the external synchronization signal.

The control unit 110 controls an operation of each unit of the image processing apparatus 100. The control unit 110 controls the image generating unit 140 such that the image generating unit 140 generates an image in a frame unit (field unit), in synchronization with the synchronization signal. In addition, the control unit 110 causes the image generating unit 140 to perform image combining while performing transition according to a progress rate from a first static status to a second static status, on the basis of an instruction of the transition from the first static status to the second static status in the complex data.

The progress rate control unit 160, the transition destination instructing unit 170, and the interface unit (I/F unit) 180 are connected to the control unit 110. The progress rate control unit 160 supplies a progress rate (from the beginning 0% to the completion 100%) of the transition to the control unit 110. The transition destination instructing unit 170 designates a transition destination. That is, when the first static status to be a current status is transited to the second static status, the transition destination instructing unit 170 selects the second static status from a plurality of static statuses of the complex data and designates the second static status as the transition destination. The I/F unit 180 supplies a control signal from the outside to the control unit 110.

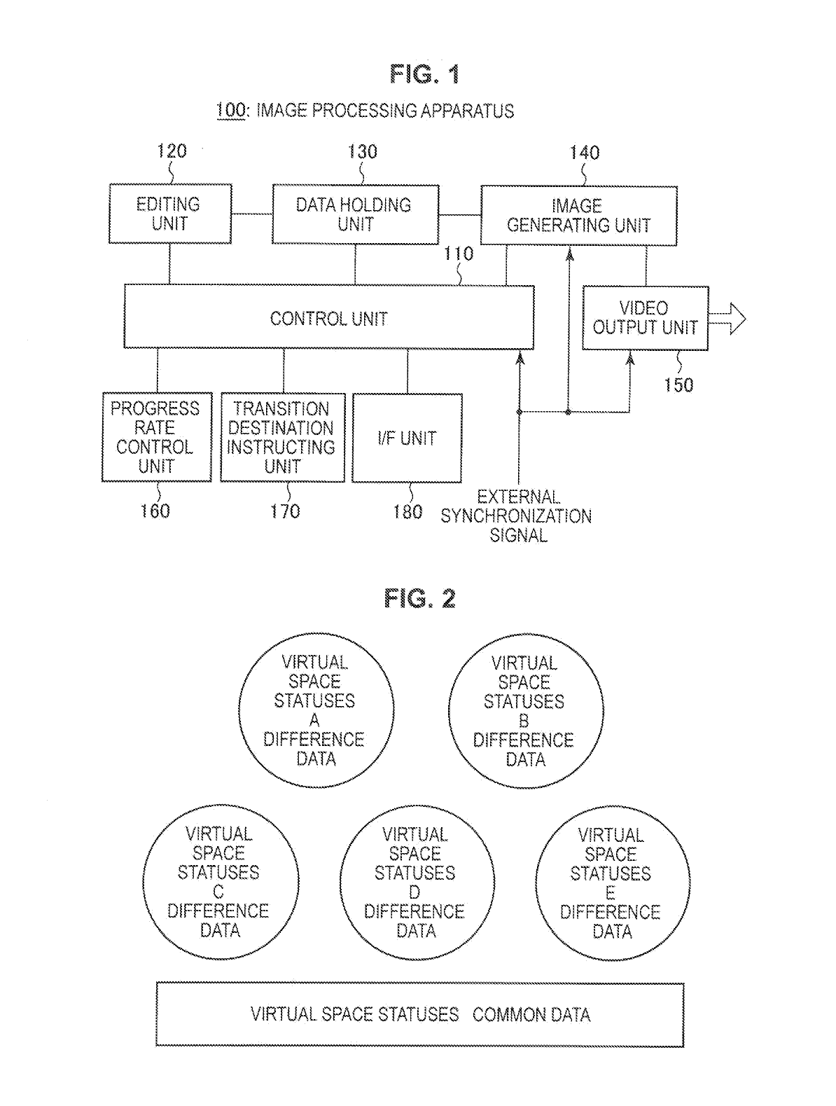

FIG. 2 illustrates the concept of the complex data. The complex data includes common data common to all virtual space statuses and difference data having different values for every virtual space status. In FIG. 2, five statuses “A” to “E” are illustrated as the virtual space statuses.

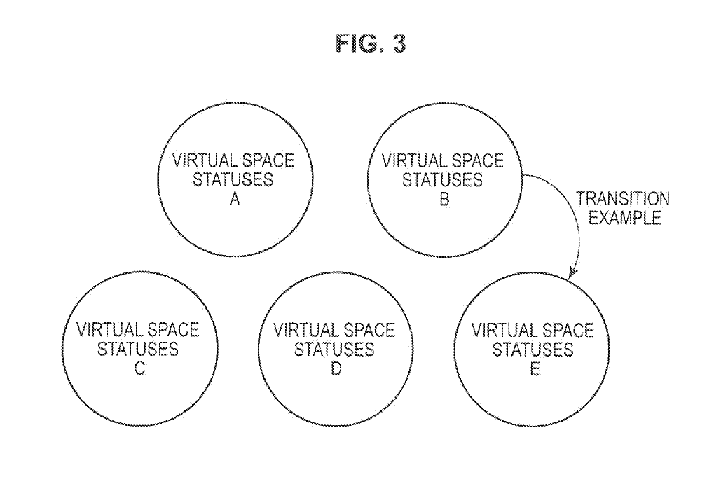

FIG. 3 illustrates a set of statuses corresponding to CG complex data and a transition example thereof. In this case, the statuses mean statuses in which values of all parameters of the virtual space by the CG data are determined and content of images generated with respect to the statuses are also determined. The images are calculated as images obtained by photographing the virtual space by virtual cameras in the virtual space. However, because the parameters of the virtual cameras are included in the “statuses” described in this case, the images are uniquely determined. However, the uniquely determined images are not limited to still images. A status in which physical simulation is performed according to a manipulation or a status in which repetitive animation is included in a part is also included in the statuses described in this case.

As a format of general CG data, for example, a Collada (registered trademark) is known. The Collada is a description definition to realize an exchange of CG data of 3D on an XML (Extensible Markup Language). A file of the Collada format can describe a scene graph and can describe and hold information regarding the timeline/animation or the physical simulation.

One status in the complex data is a static status of a virtual space described with one file of the Collada format. In order to simplify explanation, the animation is excluded. The file format may be any format in which information is the same, regardless of a conversion method. The complex data is data that can define a plurality of static statuses of the virtual space.

If the CG data of each status is simply combined, the aim is achieved. However, a data amount may excessively increase and it is necessary to execute processing for identifying a different portion (parameter) for each status. Therefore, as illustrated in FIG. 2, in the complex data, only one common data (non-changed portion data) is held with respect to an element in which values in all the statuses are not changed and only portion in which values in the individual statuses are changed is individually held as difference data. Thereby, a data amount can be decreased and processing load at the time of the transition can be alleviated.

### [Example of Data: Collada]

### Collada: XML Format

(The XML format is essentially a table of a tree structure.)

### (1) Description Example of Collada Format Defining Content of Material

<library_materials>

<material id=“PlaFinishOak”
name=“PlaFinishOak”>

<instance_effect
url=“#PlaFinishOak-Effect”/>

</material>

</library_materials>
<library_effects>

<effect id=“PlaFinishOak-Effect” name=“PlaFinishOak”>

<profile_COMMON>

<technique sid=“standard”>

<phong>

<emission>

<color sid=“emission”>0.000000 0.000000
0.0000001.000000</color>

</emission>
<ambient>

<color sid=“ambient”>0.933312 0.690960
0.4728591.000000</color>

</ambient>
<diffuse>

<color sid=“diffuse”>0.933312 0.690960
0.4728591.000000</color>

</diffuse>
<specular>

<color sid=“specular”>0.500000 0.500000
0.5000001.000000</color>

</specular>
<shininess>

<float sid-”shininess”>1.000000</float>

</shininess>
<transparency>

<float sid=“transparency”>0.000000<float>

</transparency>

</phong>

</technique>

</profile_COMMON>

</effect>

</library_effects>

In the status A, when a value of R of RGBA of ambient among the material definitions is different, difference data thereof describes a kind and a value of a parameter and can be described as follows.

<diff_sceneid=“StatusA” name=“StatusA”>
<base_scene url=“#RootNode”/>
<diff_param target=“PlaFinishOak-Effect/phong/ambient/color.R”>

0.75

</diff_param>
</diff_scene>
or
<diff_sceneid=“StatusA”name=“StatusA”>
<base_scene url=“#RootNode”/>
<diff_param target=“PlaFinishOak-Effect/phong/ambient/color”>

0.75 0.690960 0.472859 1.000000

</diff_param>
</diff_scene>
or
<diff_sceneid=“StatusA” name=“StatusA”>
<base_scene url=“#RootNode”/>
<diff_param target=“PlaFinishOak-Effect/phong/ambient/color”>

<diff_param offset=“0”>

0.75

</diff_param>

</diff param>
</diff_scene>
or
<diff_sceneid=“Status A” name=“StatusA”>
<base_scene url=“#RootNode”/>
<diff_param target=“PlaFinishOak-Effect”>

<diff_param target=“phong”>

<diff_param target=“ambient”>

<diff_param target=“color”>

<diff_param target=“R”>

0.75

</diff_param>

</diff_param>

</diff_param>

</diff_param>

</diff_param>
</diff_scene>.

### (2) Description Example of Collada Format Defining Polygon by Coordinate Value

<library_geometries>

<geometry id=“Flag1-lib” name=“Flag1Mesh”>

<mesh>

<source id=“Flag1-lib-Position”>

<float_array
id=“Flag1-lib-Position-array”count=“2004”>

82.598434−35.199100 0.000000
82.598381−29.332560 0.000000
82.598328−23.466021 0.000000
82.598267−17.599483 0.000000
82.598206−11.732941 −0.000000
82.598145−5.866402 0.000000
••• (the rest is omitted).

### (3) Description Example of Collada Format of Arrangement of Virtual Object in Virtual Space

```
<nodeid=“Flag1” name=“Flag1”>
  <translatesid=“translate”>−25.290024 −0.000001
  29.698376</translate>
  <rotate sid=“rotateX”>1 0 0 90.000003</rotate>
  <instance_geometry url=“#Flag1-lib”>
```

<bind_material>
<technique_common>

<instance_material
symbol=“PlaFinishOak”target=“#PlaFinishOak”/>

</technique_common>
</bind_material>

</instance_geometry>
</node>

•••.

In the status A, when a value of ambient among the material definitions is different and a part of the polygon and a part of the arrangement are different, a description example of difference data is as follows.

<diff_sceneid=“StatusA” name=“StatusA”>
<base_scene url=“#RootNode”/>
<diff_param target=“PlaFinishOak-Effect/phong/ambient/color.R”>

0.75

</diff_param>
<diff_param target=“Flag1-lib-Position-array”>

<diff_param offset=“4”>

−31.5

</diff_param>

</diff_param>
<diff_param target=“Flag1/translate.X”>

−21.0

</diff_param>
<diff_param target=“Flag1/rotateX.ANGLE”>

89.0

</diff_param>
</diff_scene>

The image generating unit 140 performs rendering. The image generating unit 140 generates a bitmap image for each frame/field, using parameter values of the virtual space at timing of a frame/field synchronized with a synchronization signal, such as geometry information (such as the coordinates), a surface material (material information such as a color), or light (virtual light source). The video output unit 150 outputs an image of a frame unit (or a field unit) generated by the image generating unit 140 as a video signal of an SDI signal to the outside, in synchronization with an external synchronization signal. The external synchronization signal is supplied from the outside and is commonly used by video equipments in facilities other than this apparatus. As another example, an oscillator becoming a standard may be provided in this apparatus, a terminal generating a synchronization signal and supplying the synchronization signal to the outside may be provided, and the synchronization signal may be supplied to associated video equipments.

The control unit 110 is realized by a microcomputer and software installed on the microcomputer and controls the individual units. In control of the image generating unit 140, the control unit 110 processes control to change a parameter in the frame unit (or the field unit), in synchronization with the synchronization signal. In this case, the control unit 110 is configured to receive interrupt by the synchronization signal in the microcomputer. The control unit 110 acquires a progress rate from the progress rate control unit 160 by the processing synchronized with the synchronization signal. Thereby, the parameter can be updated for each frame (or for each field) and the transition of the status of the virtual space, that is, the parameter value can be progressed.

The progress rate control unit 160 supplies the progress rate (from the beginning 0% to the completion 100%) of the transition to the control unit 110. The transition is an operation in which a value of the parameter (group) describing the virtual space transits from a certain value to a different value and a generated image changes. For example, in a state in which a vehicle in the virtual space is included in an image, the position coordinates of the vehicle in the virtual space transit from a status of a point P1 to a status of a point P2. In the middle of the transition, the position coordinates are determined by the linear interpolation. When the progress rate is F %, a point that internally divides a line connecting the points P1 and P2 by F: (100−F) becomes the position coordinates of the vehicle in the progress rate F %. Similarly, the parameters other than the position coordinates are determined by performing the internal division according to the progress rate.

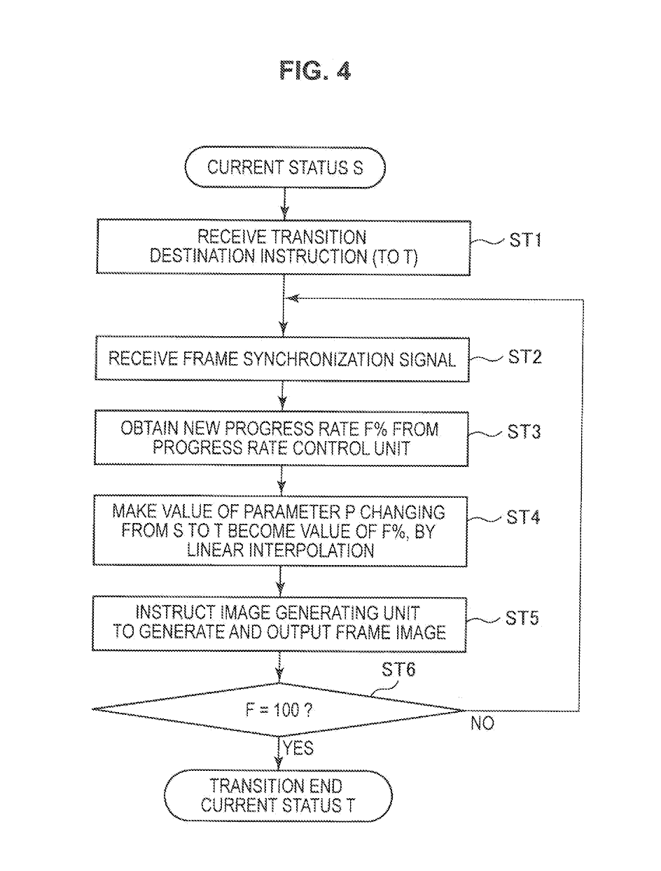

FIG. 4 is a flowchart illustrating control to receive a reception destination instruction, receive frame synchronization (VD synchronization), and perform a CG animation output. In step ST1, in a current status S, the control unit 110 receives a transition destination instruction showing the transition to T, from the transition destination instructing unit 170. Next, in step ST2, the control unit 110 receives a frame synchronization signal.

Next, in step ST3, the control unit 110 obtains a new progress rate F % from the progress rate control unit 160. Next, in step ST4, the control unit 110 makes a value of the parameter P changing from S to T become a value of F %, by the linear interpolation. In step ST5, the control unit 110 instructs the image generating unit 140 to generate a frame image and output the frame image.

Next, in step ST6, the control unit 110 determines whether F is 100. When F is not 100, the control unit 110 returns to step ST2 and prepares for reception of a next frame synchronization signal. Meanwhile, when F is 100, the transition ends and the control of the transition of the control unit 110 ends. At this time, the current status is T.

In the flowchart described above, the example of the case of using the linear interpolation is illustrated. However, a manipulation unit to designate a different interpolation method may be additionally provided and an operation may be performed using the different interpolation method. For example, the following function that is periodically changed by a sine function with respect to the progress rate F is considered.

f(F)=(½)sin(2πF/100)

Using the function, a value obtained by adding f(F) to F may be replaced with F and interpolation may be performed. In this case, when F is 25%, f(F) becomes 0.5 and a replaced value becomes 0.75. When F is 100%, f(F) becomes 0 and a replaced value becomes 1. Different from the linear interpolation, this interpolation becomes a change of the parameter progressing while oscillating. A plurality of kinds of different interpolation methods may be used.

### [Transition Destination Instructing Unit]

The transition between the statuses will be further described. The control unit 110 receives a transition destination instruction to select a status different from the current status. As a reception method, choices may be displayed on a GUI (Graphical User Interface) of the transition destination instructing unit 170 to allow a manipulator to input the transition destination instruction through the manipulation. Alternatively, a method of allowing the manipulator to select one pressing button from an arrangement of pressing buttons of the transition destination instructing unit 170 may be used. In the display of the choices, names assigned to the statuses can be displayed to help the manipulation. For example, when there are five statuses of StatusA to StatusE and a current status is the StatusC, the remaining four statuses become the choices. Therefore, four buttons of the StatusA, the StatusB, the StatusD, and the StatusE are displayed.

If the manipulator selects any button, the control unit 110 obtains a progress rate from the progress rate control unit 160, interpolates a value of a difference parameter, and generates and outputs an image changing for each frame. If the manipulator selects any button, the control unit 10 may prepare for progress to a selected status, await a trigger by a separately provided trigger manipulation unit, and start the progress when the trigger is received.

### [Progress Rate Control Unit]

As an example, the progress rate control unit 160 determines a progress rate of each frame (or each field) by a transition rate set in advance. In this case, the progress rate control unit 160 has a storage unit (memory) of the transition rate embedded therein. As a value of the transition rate, for example, a value showing the transition with 300 frames (in the case of 30 frames/sec., 10 sec.) using a frame number as a unit is stored.

In this case, in an I-th frame from the transition start, a progress rate is calculated by ((I/300)×100) % and is supplied to the control unit 110. If the transition completion is set to 100, a transition rate for each output frame becomes 100/(frame number of a transition time). A unit to input a value of the transition rate by the GUI, that is, a unit to write the value to a storage unit may be provided.

As another example, the progress rate control unit 160 manually manipulates the progress rate by a fader lever. The fader lever is a mechanism for inputting 0 to 100% from an end to an end, in an analog manner. In the case of the control using the fader lever, if the manipulator selects any choice, the control unit 110 prepares for progress to a selected status. If the fader lever is manipulated and the progress rate changes from 0%, the control unit 110 changes the generated and output image using the progress rate. If the progress rate finally becomes 100% by the fader lever, the transition is completed.

### [Editing Unit]

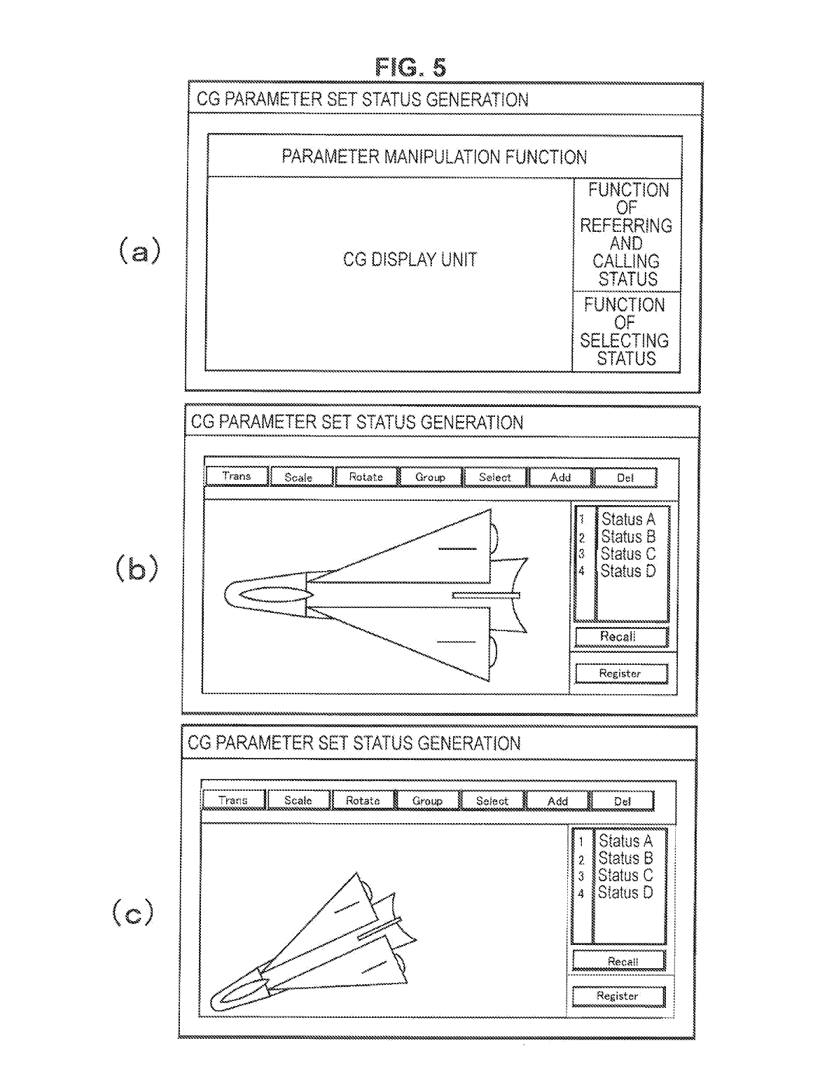

FIG. 5 is a diagram illustrating the GUI of the editing unit 120. The editing unit 120 reads a file having the Collada format generated by another apparatus. In the file, a virtual object is described by a polygon and material information regarding a surface of the virtual object is included. Even though processing is not executed by the editing unit 120, information sufficient to generate one CG image of a still image is included.

FIG. 5(b) illustrates a state in which CG data of an “airplane” is read and a rendering result thereof or a polygon is displayed. FIG. 5(a) illustrates a function of each display region of the GUI. Immediately after the data is read, only one status of the virtual space exists. The manipulator manipulates the GUI, changes the parameters of the virtual space, and registers a new status, so that the new status is added to the complex data.

As the change of the parameters, for example, processing such as movement, expansion and reduction, rotation, grouping and processing, addition, and deletion of the virtual objects (objects) exist. If the change manipulation is performed and a Register button is pressed, an input function of a name assigned to the status is displayed. If the name is input, one status is added and stored. A Recall button is a function of displaying a previously registered status. FIG. 5(c) illustrates an (simple) example where the movement and the reduction (scaling) have been performed from FIG. 5(b).

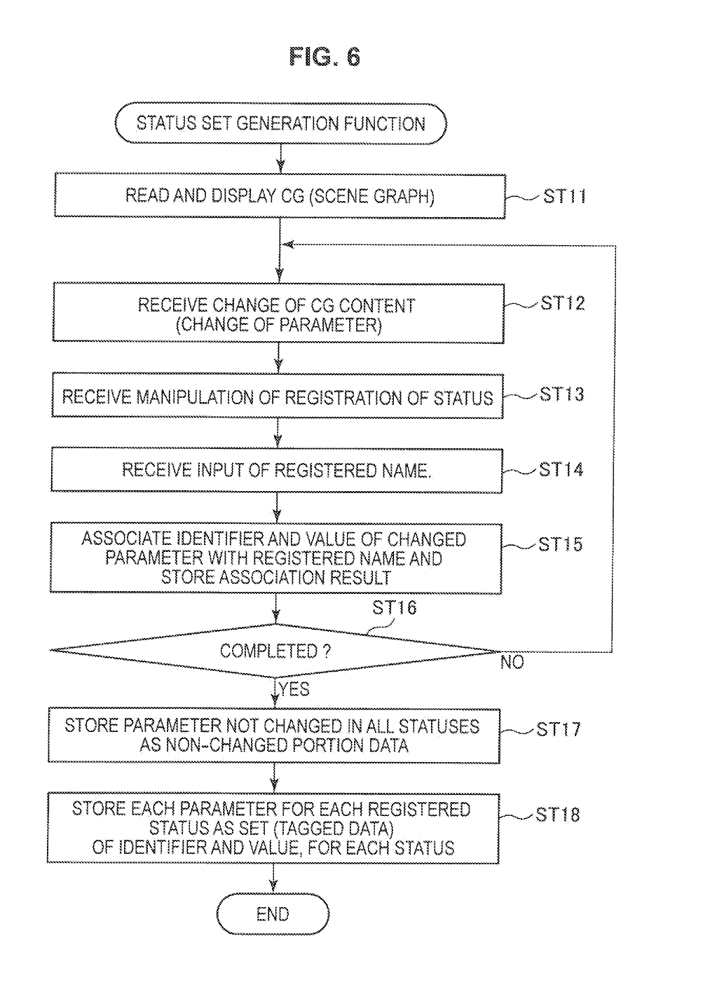

FIG. 6 is a flowchart illustrating a status set generation function of the editing unit 120. In step ST11, the editing unit 120 reads a CG (scene graph) and displays the CG Next, in step ST12, the editing unit 120 receives a change of CG content (change of parameters). In step ST13, the editing unit 120 receives a manipulation of registration of the status. In step ST14, the editing unit 120 receives an input of the registered name.

Next, in step ST15, the editing unit 120 associates an identifier and a value of the changed parameter with the registered name and stores an association result. In step ST16, the editing unit 120 determines whether the association and the storage are completed. When the association and the storage are not completed, the editing unit 120 returns to step ST12 and repeats the same processing as the processing described above.

Meanwhile, when the association and the storage are completed, in step ST17, the editing unit 120 stores the parameters not changed in all the statuses as non-changed portion data (common data). In step ST18, the editing unit 120 stores each parameter for each registered status as a set (tagged data) of an identifier and a value, for each status. Thereby, the editing unit 120 ends the status set generation.

When the virtual object is added or deleted, in the transition between the statuses, a handling method of the virtual object is not determined by only the interpolation. In this case, in a state in which the virtual object does not exist, it is assumed that the virtual object exists with a zero size at the same position as a state in which the virtual object exists, a size is interpolated, and the same transition as the other case is enabled. Alternatively, as an example of another method, in a state in which the virtual object does not exist, a material of an entire surface (surface material) of the virtual object may be set to a transparent material (a is zero) and a may be interpolated at the time of the transition, so that the transition may gradually appear in the image.

### [Editing Unit (Automatic Extraction Type)]

Another example of the editing unit 120 will be described. In the example described above, the editing unit 120 reads the CG data of the still image and processes the CG data. In this example, the editing unit 120 reads the CG data (file having the Collada format) that has the timeline/animation. In the timeline/animation, a plurality of key frame points exist on the timeline. With respect to the parameters of the timeline targets, a value is written for each key frame point. In this example, the key frame points are extracted as the static statuses and each key frame point is stored as a status in which all the parameters are defined, in the complex data. The name of each status can be automatically assigned. In this case, names such as sequential numbers or A, B, and C are assigned.

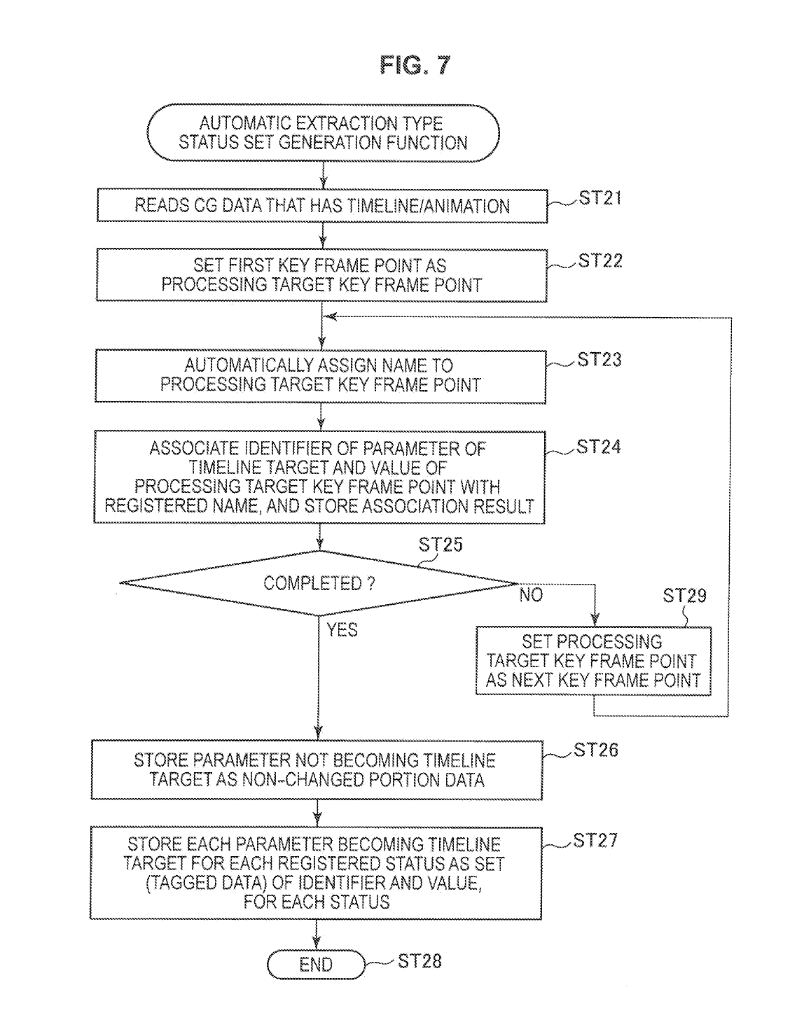

FIG. 7 is a flowchart illustrating an automatic extraction type status set generation function of the editing unit 120. In step ST21, the editing unit 120 reads the CG data that has the timeline/animation. In step ST22, the editing unit 120 sets a first key frame point as a processing target key frame point.

Next, in step ST23, the editing unit 120 automatically assigns a name to the processing target key frame point. In step ST24, the editing unit 120 associates the identifier of the parameter of the timeline target and the value of the processing target key frame point with the registered name and stores an association result.

Next, in step ST25, the editing unit 120 determines whether the association and the storage are completed. When the association and the storage are not completed, the editing unit 120 proceeds to step ST29, sets the processing target key frame point as a next key frame point, returns to step ST23, and repeats the same processing as the processing described above. Meanwhile, when the association and the storage are completed, in step ST26, the editing unit 120 stores the parameter not becoming the timeline target as the non-changed portion data (common data). In step ST27, the editing unit 120 stores each parameter becoming the timeline target for each registered status as a set (tagged data) of an identifier and a value, for each status. Thereby, the editing unit 120 ends the status set generation.

### [Hierarchy/Group]

In the examples described above, the state transition is equally handled with respect to all the parameters of the virtual space. Meanwhile, a video manipulation of a higher added value is enabled by dividing the parameters of the virtual space into groups and handling the state transition individually with respect to each of a plurality of groups.

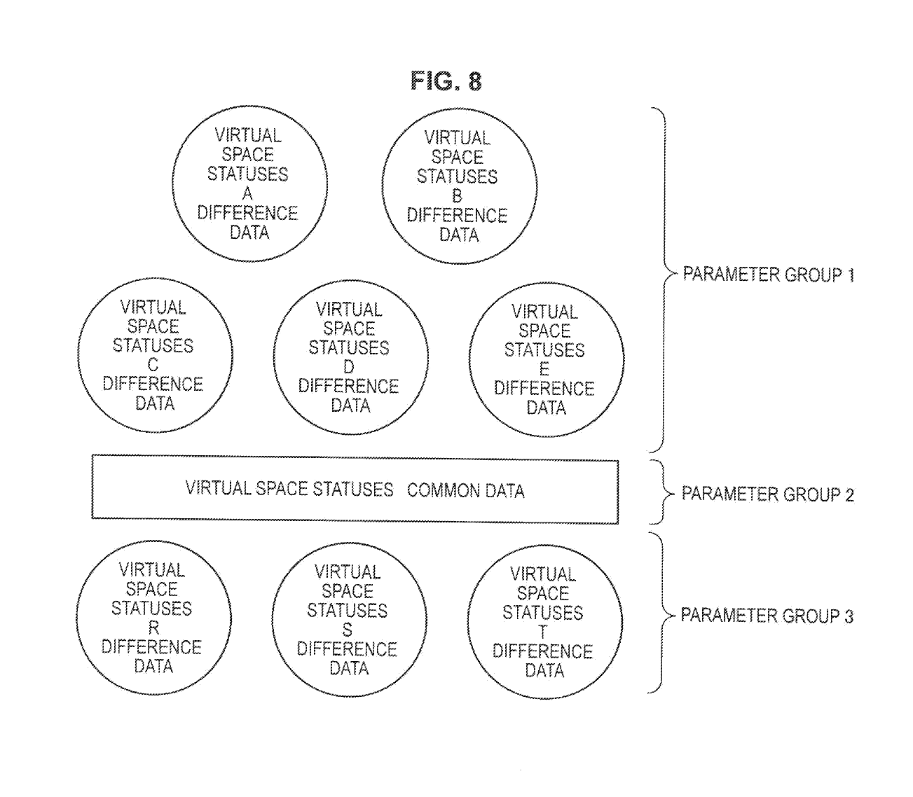

FIG. 8 illustrates a structure and a concept of group configuration CG complex data. The parameters of the virtual space are divided into three groups 1, 2, and 3. The group 2 is not set as a manipulation target. In the group 1, values for every five statuses are stored in the complex data. In the group 3, values for every three statuses are stored in the complex data.

As the transition destination instructing unit 170 that inputs the transition destination instruction to the control unit 110, a GUI to manipulate and input four choices other than a current status is provided with respect to the group 1 and a GUI to manipulate and input two choices other than the current status is provided with respect to the group 3. Thereby, the parameter groups of the groups 1 and 3 can be independently and immediately transited to any status.

For example, if a position is set to the group 1 and a rotation angle is set to the group 3 with respect to a certain virtual object in the virtual space, a manipulation is enabled in parallel and independently, with respect to the position and the rotation angle. Alternatively, if the position and the rotation angle are set to the group 1 and a color of the surface is set to the group 3, the color can be independently changed while the position and the rotation angle are manipulated.

Technology for enabling the parameters of the CG virtual space to be manipulated by a knob already exists. However, in the case of the group of the plurality of parameters like the position and the rotation angle, even though a plurality of scalar values constituting a vector value are manipulated by the knob, an immediate good manipulation is difficult. Meanwhile, in the present disclosure for previously registering the status of each parameter and transiting the status to the registered status, even though the plurality of scalar values are changed, the status can be transited to a desired status by one manipulation. The manipulation can be facilitated by dividing the parameters into the groups.

In the case in which the position and the color are manipulated in one status space, when five kinds of positions and three kinds of colors are registered, a total of statuses are generated. Meanwhile, as illustrated in FIG. 8, if the position and the color are manipulated in different status spaces, choices are 8 (5+3) and movement to an image with a plurality of variations can be easily manipulated.

As the group division of the parameters, for example, in a virtual space in which a person gets in the vehicle, a position of the vehicle can be set as one group and movement (posture) of the person who gets in the vehicle can be set as one group. If the person who gets in the vehicle becomes a scene graph configuration (group configuration; a configuration of a group different from the group described herein) following the position of the vehicle, the position of the vehicle and an aspect of the person in the vehicle can be separately manipulated. The groups that become status transition targets are not limited to two.

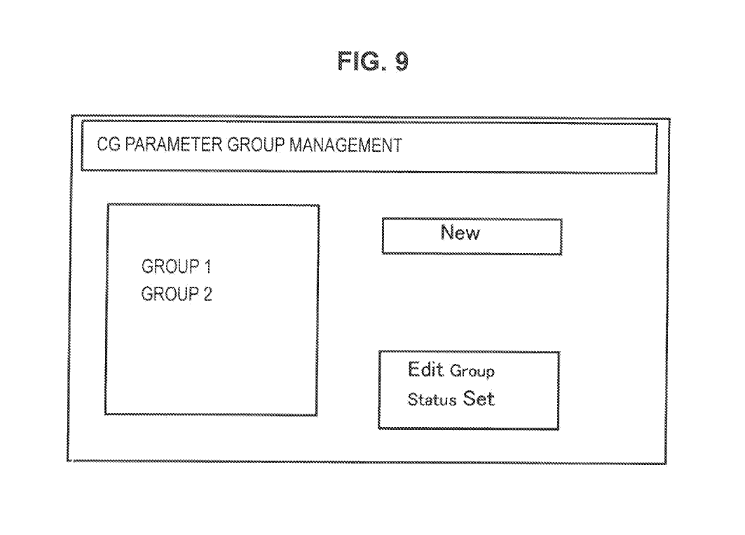

The editing unit 120 manipulates the status set generation function for each group, with respect to the read equal CG data. First, the editing unit 120 displays the GUI illustrated in FIG. 9, selects new generation (New) (urging an input of a name) with respect to a group to make a status group, and displays an editing (EditGroup Status Set) button. If the editing button is clicked, the editing unit 120 displays the same GUI as FIG. 5 and receives the change of the parameter and the registration of the status. However, the editing unit 120 does not receive the change manipulation, with respect to the parameter that has become the change target in the different group.

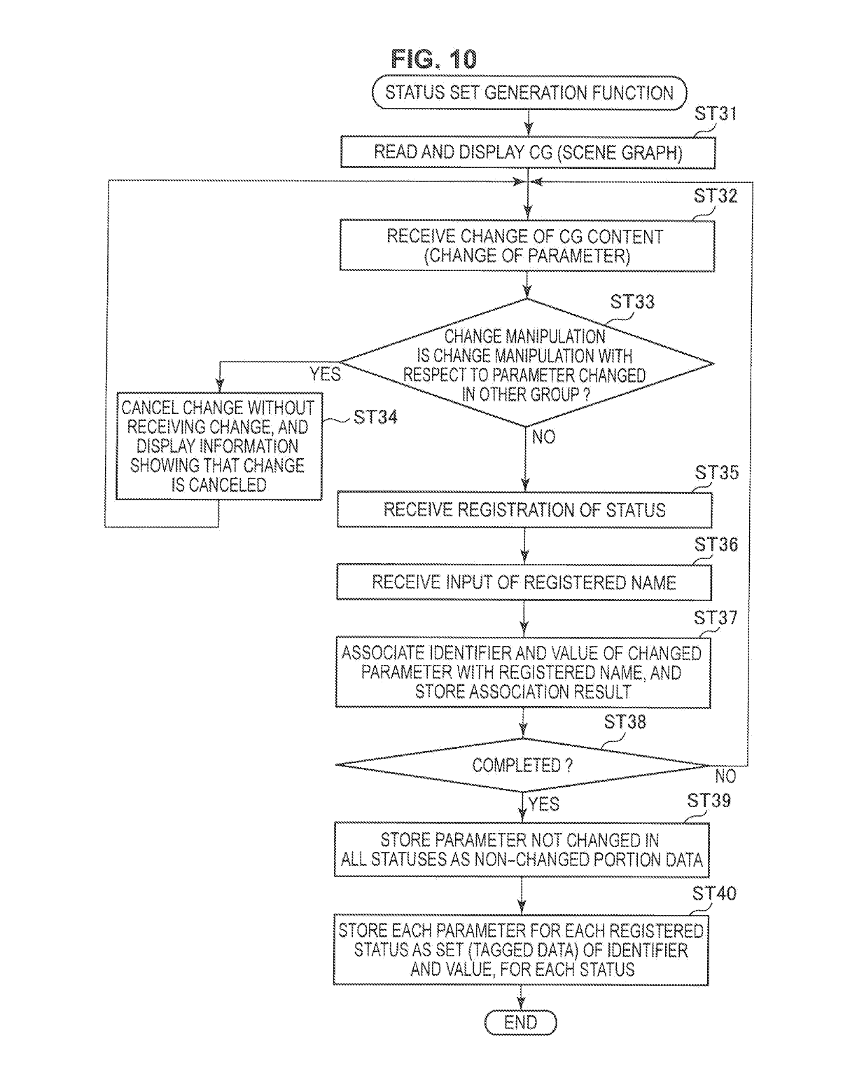

FIG. 10 is a flowchart illustrating the status set generation function of the editing unit 120. In FIG. 10, a step of refusing the change manipulation is added. In step ST31, the editing unit 120 reads the CG (scene graph) and displays the CG Next, in step ST32, the editing unit 120 receives a change of CG content (change of parameters).

Next, in step ST33, the editing unit 120 determines whether the change manipulation is a change manipulation with respect to the parameter changed in other group. When the change manipulation is the change manipulation with respect to the parameter changed in other group, in step ST34, the editing unit 120 cancels the change without receiving the change and displays information showing that the change is cancelled. The editing unit 120 returns to step ST32. Meanwhile, when the change manipulation is not the change manipulation with respect to the parameter changed in other group, in step ST35, the editing unit 120 receives registration of the status. In step ST36, the editing unit 120 receives an input of the registered name.

Next, in step ST37, the editing unit 120 associates an identifier and a value of the changed parameter with the registered name and stores an association result. In step ST38, the editing unit 120 determines whether the association and the storage are completed. When the association and the storage are not completed, the editing unit 120 returns to step ST32 and repeats the same processing as the processing described above.

Meanwhile, when the association and the storage are completed, in step ST39, the editing unit 120 stores the parameters not changed in all the statuses as non-changed portion data (common data). In step ST40, the editing unit 120 stores each parameter for each registered status as a set (tagged data) of an identifier and a value, for each status. Thereby, the editing unit 120 ends the status set generation.

First, the editing unit 120 may perform the group definition of the parameters. Next, the editing unit 120 may receive the editing manipulation illustrated in FIG. 5 or an editing manipulation using a numerical value input, with respect to each parameter. In the group definition, the parameters of the CG virtual space are displayed by a tree, a portion of the tree (parent node in the case in which the parameter is not an independent parameter) is selected, and the portion is defined as a group and is stored. Then, the editing unit 120 selects the defined group, receives the editing manipulation, and stores the status group of the group in the complex data. The CG displayed GUI illustrated in FIG. 5 or a unit that directly inputs the parameters in the group by numerical values and registers a result as a status may receive the editing manipulation.

In the example described above, the editing unit 120 reads the CG data of the still image and processes the CG data. In a next example, the editing unit 120 reads CG data (file having a Collada format) that has the timeline/animation. In the CG data having the timeline, CG data having a plurality of timelines exists. Specifically, the timelines are divided into some parts, not a collection of all the parameters set as the change targets, and the positions of the key frame points are different. If the parameters of the timelines in which all the positions of the key frame points are the same are collected as a group with respect to the CG data, the group (group division of the parameters) described above can be automatically generated. Then, the status is registered as the status for each key frame point, for each group.

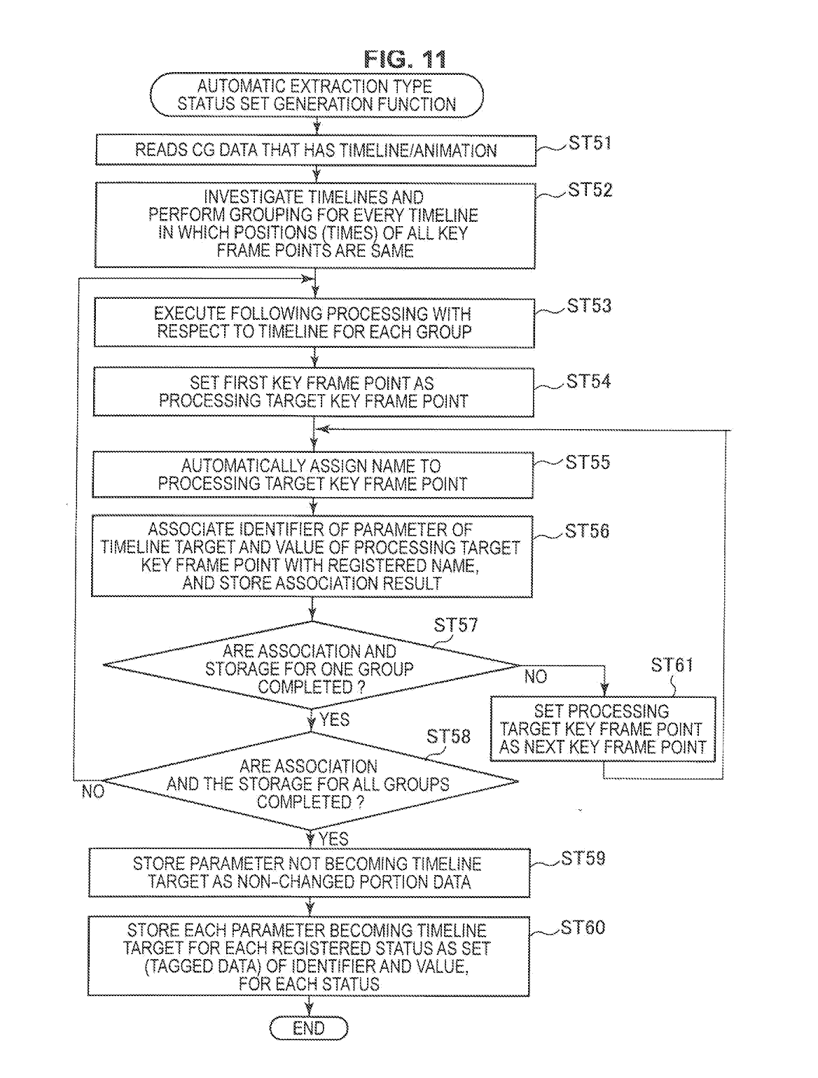

FIG. 11 is a flowchart illustrating an automatic extraction type status set generation function of the editing unit 120. In step ST51, the editing unit 120 reads the CG data that has the timeline/animation. In step ST52, the editing unit 120 investigates the timelines and performs grouping data for every timeline in which the positions (times) of all the key frame points are the same.

Next, in step ST53, the editing unit 120 executes the following processing with respect to the timeline for each group. In step ST54, the editing unit 120 sets the first key frame point as the processing target key frame point. In step ST55, the editing unit 120 automatically assigns a name to the processing target key frame point.

Next, in step ST56, the editing unit 120 associates the identifier of the parameter of the timeline and the value of the processing target key frame point with the registered name and stores an association result. In step ST57, the editing unit 120 determines whether the association and the storage for one group are completed. Meanwhile, when the association and the storage for one group are not completed, the editing unit 120 proceeds to step ST61, sets the processing target key frame point as a next key frame point and returns to step ST55. When the association and the storage for one group are completed, the editing unit 120 proceeds to processing of step ST58.

In step ST58, the editing unit 120 determines whether the association and the storage for all groups are completed. When the association and the storage for all groups are not completed, the editing unit 120 returns to step ST53. Meanwhile, when the association and the storage for all groups are completed, the editing unit 120 proceeds to processing of step ST59. In step ST59, the editing unit 120 stores the parameter not becoming the timeline target as non-changed portion data (common data). In step ST60, the editing unit 120 stores each parameter becoming the timeline target for each registered status as a set (tagged data) of the identifier and the value, for each status. Thereby, the editing unit 120 ends the status set generation.

### [Linked Transition]

Linked transition such as the case in which snow falls and ice is formed in the virtual space when the temperature decreases will be described. The I/F unit 180 supplies a control signal from the outside to the control unit 110. In the examples described above, the transition destination instruction is a manual manipulation input from the GUI. However, the control can be configured to execute the transition destination instruction and the trigger by the control signal from the outside.

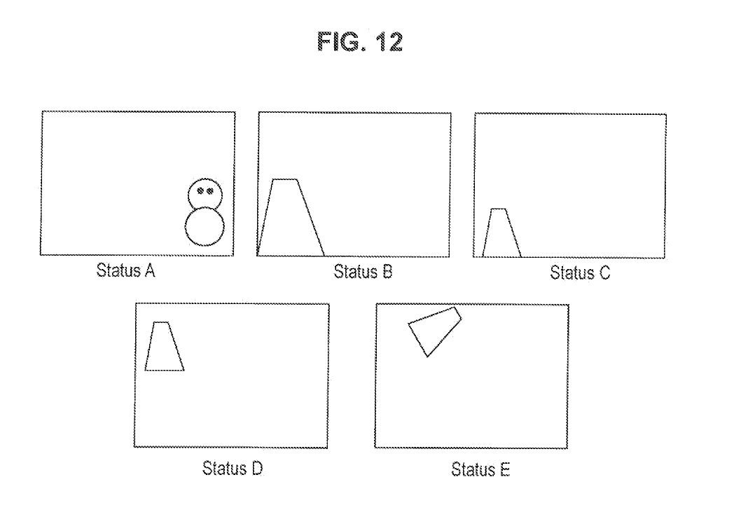

For example, temperature data is used as base data of the control and the temperature data can be associated with the statuses A to E, according to the temperature. The temperature data can be set to the status A in 0 degree or less, can be set to the status B in 0 to 10 degrees, can be set to the status C in 10 to 20 degrees, can be set to the status D in 20 to 30 degrees, and can be set to the status E in 30 degrees or more. The control is configured such that the transition (trigger) is executed at the same time as when the temperature changes. FIG. 12 illustrates an example of a CG image that is generated by the control. As described above, the parameters are interpolated when the transition is performed, with respect to the same virtual object. For this reason, when the size changes, the virtual object appears such that the size gradually changes. As an additive control function, a configuration (setting of a delay time) to execute the trigger within a range of predetermined sec. after the temperature changes is enabled.

[Restriction of Transition according to Condition]

A configuration to apply restriction to the transition according to a situation (external factor) is considered. For example, the restriction is applied to the transition as follows. That is, (1) when one of input images (one or more image signals from the outside in the case of the configuration in which the apparatus according to the present disclosure receives the image signal from the outside) is in an NG image, the restriction is applied such that the NG image is not included in an output image and (2) in the case of a configuration to add a stock price graph of a market to an output image, the restriction is applied such that a real-time stock price graph is not included in the output image, until the market starts.

By the control signal from the outside, the selection in the transition destination instruction or the transition execution status may be restricted. For example, the transition status can be changed according to a time from 6:00 to 18:00 and the other time in a day. For example, a configuration to permit or prohibit the transition to a status in which the virtual object is included in frames of the output image according to whether content of the input image may be used or may not be used when the input image is texture-mapped to the surface of the virtual object and a result is included in the output image can be used.

As described above, in the image processing apparatus 100 illustrated in FIG. 1, the image combining by the CG can be performed while the transition can be performed according to the progress rate from the first static status to the second static status, on the basis of the instruction of the transition from the first static status to the second static status in the complex data having the plurality of static statuses of the virtual space. For this reason, a generated CG image can be changed with an action according to a manipulation intention of a manipulator.

### 2. Second Embodiment

### [Configuration of Image Processing Apparatus]

FIG. 13 illustrates a configuration example of an image processing apparatus 100A according to a second embodiment of the present disclosure. In FIG. 13, portions corresponding to FIG. 1 are denoted with the same reference numerals and explanation thereof is omitted. The image processing apparatus 100A includes a control unit 110, a computer graphics (CG) making unit 200, an editing unit 120, a data holding unit 130, a network 210, an image generating unit 140, and an image mapping unit 220. The image processing apparatus 100A further includes a matrix switch 230, a switcher console 240, and an M/E bank 250. The control unit 110, the editing unit 120, the data holding unit 130, the image generating unit 140, and the CG making unit 200 are connected to the network 210.

The CG making unit 200 is configured using a personal computer (PC) that has CG making software. The CG making unit 200 outputs CG description data that has a predetermined format. As the format of the CG description data, for example, Collada (registered trademark) is known. The Collada is a description definition to realize an exchange of CG data of 3D on an extensible markup language (XML). In the CG description data, for example, the following information is described.

### (a) Definition of Material (Surface Aspect)

The definition of the material is a material (visibility) of a surface of a CG object. In the definition of the material, information such as a color, a reflection fashion, light emission, and unevenness is included. In the definition of the material, information of texture mapping may be included. The texture mapping is a method of attaching an image to a CG object as described above and can express a complicated pattern while relatively alleviating load of a processing system.

### (b) Definition of Geometry Information

In the definition of the geometry information, information such as position coordinates and vertex coordinates with respect to a polygon mesh is included.

### (c) Definition of Camera

In the definition of the camera, parameters of the camera are included.

### (d) Definition of Animation

In the definition of the animation, various information in each key frame of the animation is included. In the definition of the animation, time information in each key frame of the animation is included. The various information is information such as a time of a key frame point of a corresponding object (node), coordinate values of the position and the vertex, a size, a tangent vector, an interpolation method, and a change of each information in the animation.

### (e) Definition of Position, Direction, and Size of Node (Object) in Scene, Corresponding Geometry Information Definition, and Corresponding Material Definition

The above information is not scattered and is associated as follows.

Node . . . Geometry Information

Node . . . Material (Plural)

Geometry Information . . . Polygon Set (Plural)

Polygon Set . . . Material (One of Materials Corresponding to Node)

Animation . . . Node

The description that constitutes one screen is called a scene. Each definition is called a library and is referred to from the scene. For example, when two cuboid objects exist, each of the objects is described as one node and any one of the material definitions is associated with each node. As a result, the material definition is associated with each cuboid object and each cuboid object is drawn with a color a reflection characteristic according to each material definition.

Alternatively, the cuboid object is described with a plurality of polygon sets. When the material definition is associated with the polygon set, the cuboid object is drawn with the material definition different for each polygon set. For example, surfaces of the cuboid are 6. However, the cuboid object may be described with three polygon sets, using one polygon set in three surfaces, one polygon set in one surface, and one polygon set in two surfaces. Because the different material definition can be associated with each polygon set, the object can be drawn with a different color for each surface.

When the texture mapping is designated with respect to the material definition, an image based on image data is texture-mapped to the associated object surface.

For example, setting is performed to texture-map the image to the material definition. For this reason, the same image can be texture-mapped to all the surfaces of the cuboid object and the image different for each surface can be texture-mapped.

The editing unit 120 generates complex data with a plurality of static information of the virtual space, on the basis of the CG description data generated by the CG making unit 200. The data holding unit 130 holds the complex data that is edited by the editing unit 120. The image generating unit 140 generates an image by performing image combining by the CG, on the basis of the complex data held in the data holding unit 130, and outputs image data Vout to an output terminal 140a.

The matrix switch 230 selectively extracts a predetermined image (image data) from a plurality of input images (input image data). The matrix switch 230 has a plurality of input lines 311, a plurality of output bus lines 312, and a plurality of cross point switch groups 313. The matrix switch 230 constitutes a part of an effect switcher. The matrix switch 230 supplies image data to the image mapping unit 220 corresponding to an external apparatus and supplies the image data to the internal M/E bank 250.

Each cross point switch group performs each connection at each of the cross points where the plurality of input lines and the plurality of output bus lines cross. On the basis of an image selection manipulation of a user, connection is controlled in each cross point switch group and any one of the image data input to the plurality of input lines is selectively output to each output bus line.

The image data is input from a VTR and a video camera to the input lines “1” to “9” among the plurality of input lines, in this embodiment, the 10 input lines and the CG image data that is output from the image generating unit 140 is input to the input line “10”. The partial output bus lines of the plurality of output bus lines are bus lines to supply image data for texture mapping (mapping inputs) T1 to T4 to the image mapping unit 220. The partial output bus lines of the plurality output bus lines constitute output lines of image data OUT1 to OUT7 for external outputs.

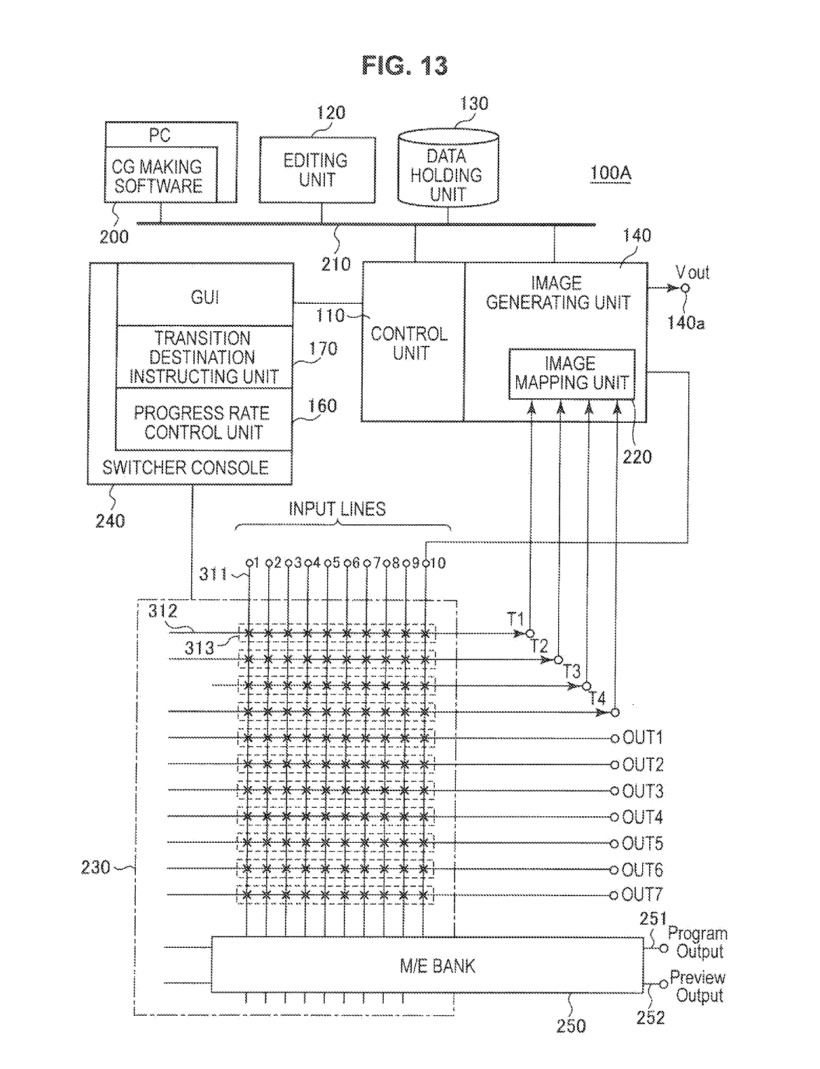

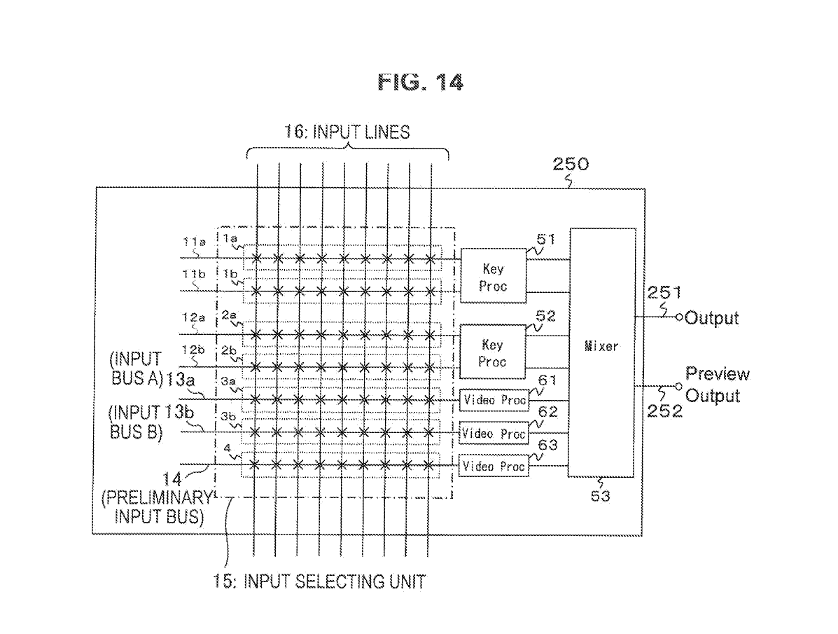

FIG. 14 illustrates a configuration example of the M/E bank 250. The M/E bank 250 includes an input selecting unit 15, key processors (key processing circuits) 51 and 52, a mixer (image combining unit) 53, and video processing units 61 to 63. The input selecting unit 15 connects each of input lines 16 to key source buses 11a and 12a, key fill buses 11b and 12b, a background A bus 13a, a background B bus 13b, and a preliminary input bus 14.

Between each of the input lines 16 and the key source buses 11a and 12a, key source selection switches 1a and 2a to select key source signals from a plurality of image signals of the input lines 16 are provided. Between each of the input lines 16 and the key fill buses 11b and 12b, key fill selection switches 1b and 2b to select key fill signals from the plurality of image signals of the input lines 16 are provided.

The key source signals that are selected by the key source selection switches 1a and 2a and are extracted in the key source buses 11a and 12a are transmitted to the key processors 51 and 52. The key fill signals that are selected by the key fill selection switches 1b and 2b and are extracted in the key fill buses 11b and 12b are transmitted to the key processors 51 and 52. The key fill signal is a signal of an image that is overlapped as a front view to a background image and the key source signal is a signal to designate an overlapping region of the key fill signal, a cut shape of the background image, and the density of the key fill signal with respect to the background image.

Between each of the input lines 16 and the background A bus 13a, a background A selection switch 3a to select a background A signal from the plurality of image signals of the input lines 16 is provided. Between each of the input lines 16 and the background B bus 13b, a background B selection switch 3b to select a background B signal from the plurality of image signals of the input lines 16 is provided. Between each of the input lines 16 and the preliminary input bus 14, a preliminary input selection switch 4 to select a preliminary input signal from the plurality of image signals of the input lines 16 is provided.

The background A signal that is selected by the background A selection switch 3a and is extracted in the background A bus 13a is transmitted to the mixer 53 through the video processing unit 61. The background B signal that is selected by the background B selection switch 3b and is extracted in the background B bus 13b is transmitted to the mixer 53 through the video processing unit 62. The preliminary input signal that is selected by the preliminary input selection switch 4 and is extracted in the preliminary input bus 14 is transmitted to the mixer 53 through the video processing unit 63.

The key processors 51 and 52 are circuits that adjust and process the key fill signal and the key source signal to be suitable for keying, on the basis of key adjustment values to be various parameters to perform the keying. The key adjustment values are the following values. That is, the key adjustment values are a value to adjust the density of the key fill signal with respect to the background image, a value to adjust a threshold value of a signal level of an image to be determined as the key source signal, a value to adjust a position of the key source signal, a value to adjust a reduction ratio of the key fill signal, and an adjustment value regarding a boundary line with the background image.

The key fill signal and the key source signal that are adjusted and processed by the key processors 51 and 52 are transmitted to the mixer 53. The mixer 53 is a circuit that overlaps a front view image to the background image by the keying, using the key fill signal and the key source signal from the key processors 51 and 52. In addition, the mixer 53 has a function of combining the background A signal transmitted through the video processing unit 61 and the background B signal transmitted through the video processing unit 62, generating a background image, and performing switching transition of the background image based on wipe used in the combining. A program output is output from the mixer 53 to the outside through a program output line 251. A preview output is output from the mixer 53 to the outside through a preview output line 252.

The control unit 110 controls an operation of each unit of the image processing apparatus 100A. The control unit 110 controls the image generating unit 140 such that the image generating unit 140 generates an image in a frame unit (field unit), in synchronization with a synchronization signal (external synchronization signal). In addition, the control unit 110 causes the image generating unit 140 to perform image combining while performing transition according to a progress rate from a first static status to a second static status, on the basis of an instruction of the transition from the first static status to the second static status in the complex data.

The switcher console 240 receives a manipulation input of an instruction with respect to the matrix switch 230. Although not illustrated in FIG. 14, the switcher console 240 includes a button column to manipulate On/Off of switches of each cross point switch group of the matrix switch 230. The switcher console 240 also has a function of receiving various manipulation inputs with respect to the control unit 110. That is, the switcher console 240 has a progress rate control unit 160 and a transition destination instructing unit 170.

The progress rate control unit 160 supplies a progress rate (from the beginning 0% to the completion 100%) of the transition to the control unit 110. The transition destination instructing unit 170 designates a transition destination. That is, when the first static status to be a current status is transited to the second static status, the transition destination instructing unit 170 designates the second transition destination as the transition destination.

### [Graph Structure]

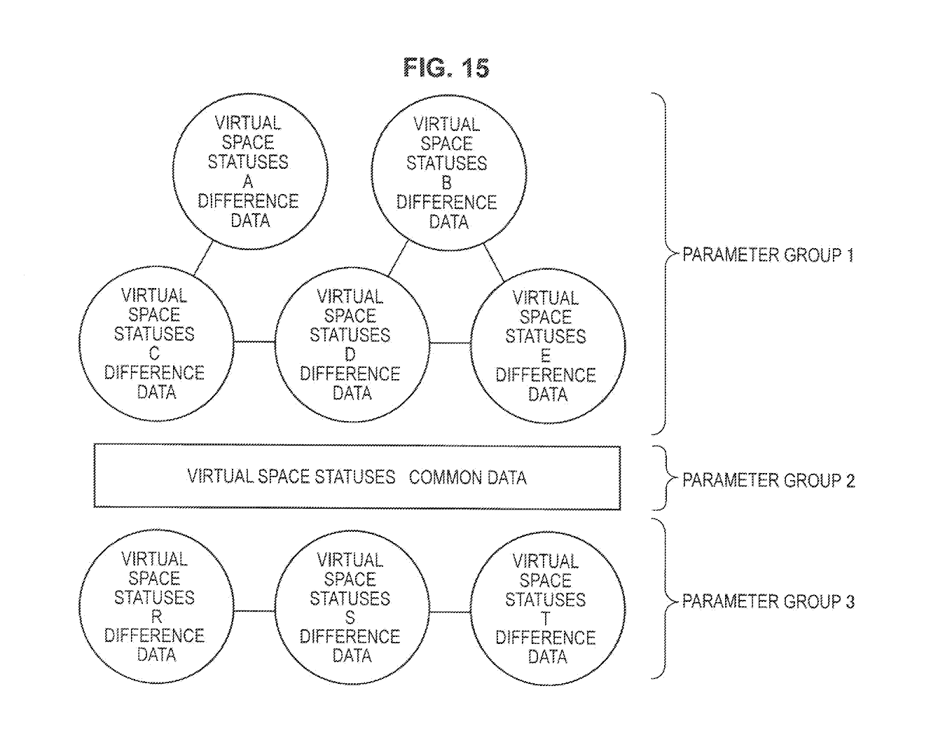

FIG. 15 illustrates a graph structure according to an example of complex data. Each status of one parameter group is connected by the side of the graph to form the graph structure. As the choices of the transition destination instruction, statuses (nodes) that are connected to a current status by the side are displayed. For example, when the current status is a status A, only one choice C exists. When the current status is a status D, three choices B, C, and E exist. The manipulator selects one choice from the displayed choices, executes the trigger, and transits the current status to the selected status, so that the manipulator can change an output image. In this case, a data structure that holds the length of a time in the side of the complex data of the graph structure is configured. When the control unit 110 executes the transition of the side, the control unit 110 uses the time length of the side.

For example, in the case in which a robot is arranged in the virtual space and a status in which the robot is in bed is set to A, a status in which the robot is standing up is set to C, a status in which the robot stands up is set to D, a status in which the robot takes a step forward is set to B, and a status in which the robot raises hands is set to E, if the status in which the robot is in bed is transited to the status in which the robot stands up without the middle status C, natural movement is not obtained even though the geometry information such as the coordinate value of each unit is interpolated. For this reason, only the statuses of which the transitions are proper are connected by the sides, by the graph structure using the status as the node, so that only a natural CG image can be output in the immediate manipulation operation.

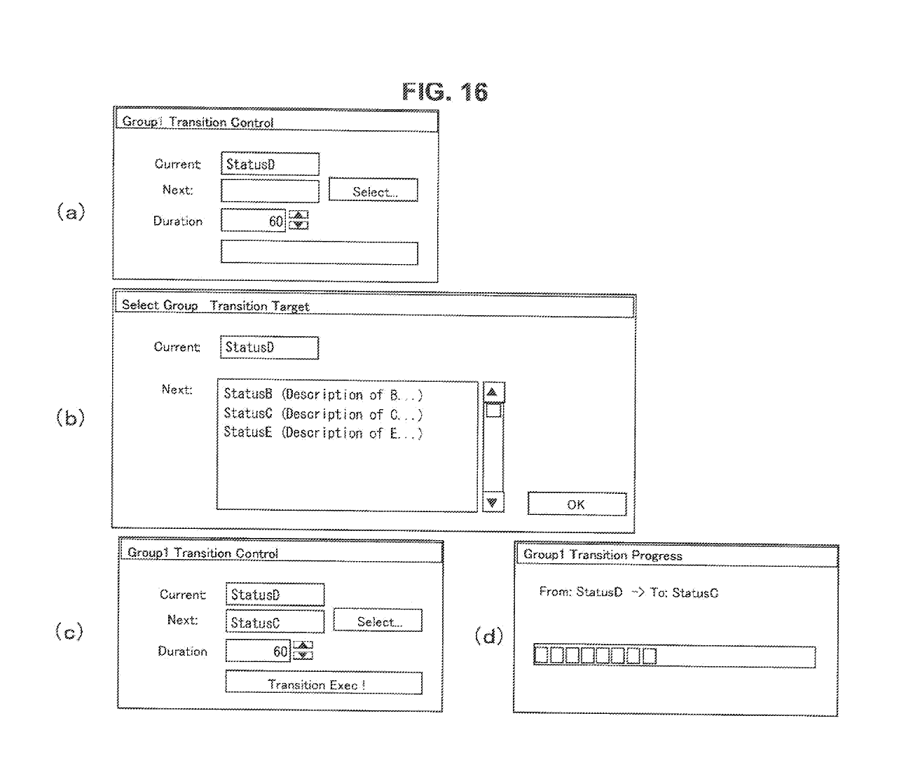

FIG. 16 illustrates an example of a GUI regarding a transition instruction. FIG. 16(a) illustrates GUI display before inputting a transition destination instruction. In this case, FIG. 16(a) illustrates an example of the group 1 of FIG. 15. If a Select button is pressed (clicked), display becomes GUI display of FIG. 16(b). The GUI is a GUI to input the transition destination instruction. A list of statuses in which the transition from the current status is enabled is displayed in a list box of Next. Statuses in which the transition is disabled are not displayed.

If one of the list of statuses is selected and an OK button is pressed, an input of the transition destination instruction is completed. FIG. 16(c) illustrates display of a state in which the transition destination (Next) is fixed. If a Transition Exec! button is pressed, the transition starts. During the execution of the transition, a progress bar illustrated in FIG. 16(d) is displayed. The examples using the GUI are described above. However, the same UI may be realized by a displayer/button of a console.

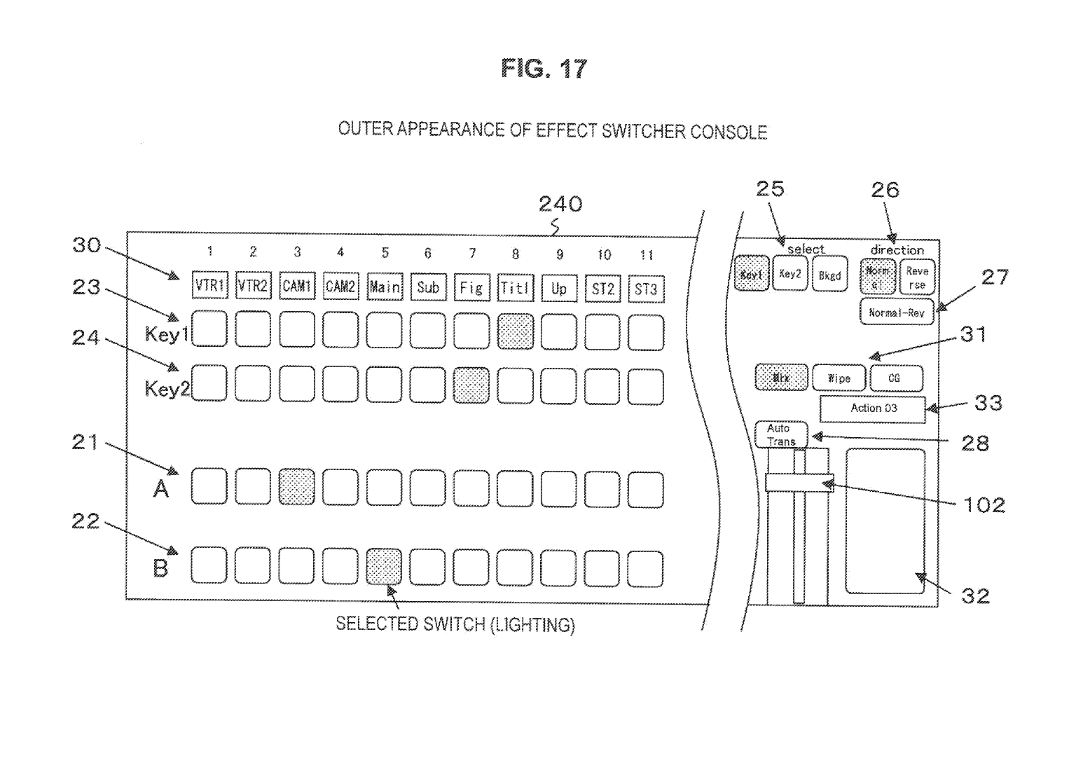

FIG. 17 illustrates an example of an outer appearance (manipulation surface) of a switcher console 240. At the side of a right end of FIG. 17, an example of a block (group of a manipulator) to manipulate transition of image combining/switching, that is, transition is illustrated. A transition target selection button (Next Transition Selection) 25 determines a transition function that is controlled by the block. That is, the transition target selection button 25 designates whether next executed transition is a manipulation to switch (replace) the A bus and the B bus of the background buses or a manipulation to switch On/Off of any keyer.

In the switcher console 240, keyers of two systems of a key 1 (Key1) and a key 2 (Key2) exist. The number of systems of the keyers may be more than 2 or less than 2. Cross point button columns 23 and 24 are used for selection of input images of the key 1 system and the key 2 system. Cross point button columns 21 and 22 are used for selection of the input images of the A bus and the B bus of the background buses. The cross point button column has a function of manipulating control to supply an input signal (video) corresponding to the pressed button to the corresponding bus.

A direction designation button 26 receives a designation manipulation, when Normal and Reverse exist in progress methods of the transition and the progress methods can be selected. A Normal-Reverse (Normal-Rev) button 27 receives a designation manipulation to alternately switch the Normal and the Reverse and operate the progress method. A fader lever 102 is a manipulator to manually control a progress of the transition.

An automatic transition (AutoTrans) button 28 instructs to automatically perform the progress of the transition (progresses in proportional to a time to progress to 100% at a preset time). A transition type selection button 31 is a button to select a transition type. In this case, in addition to Mix (an entire screen is overlapped and combined with a ratio of the parameters) and wipe (a screen is divided by a wipe pattern waveform and is combined), any CG (overlapping and combining of a CG image) can be selected and manipulated. A ten key input unit 32 is a button group that can input numerical values and can input a number such as a number of a wipe pattern and the like.

Each button may be configured to have a character displayer on a surface, enable setting of a function, and enable dynamic allocation showing the function by display. A displayer 33 displays the wipe number or the transition destination that is instructed by the manipulation. A source name displayer column 30 displays character information that is associated with an index number of a matrix switch corresponding to a button number of a button arranged on a lower side. The character information is stored in a memory not illustrated in the drawing in the switcher console 240 and the user can set the character information.

Next, a sequence for manipulating and inputting the instruction of the transition by the switcher console 240 and display (response) according to the sequence will be described. In the example of FIG. 17, Mix is selected in the transition type selection button 31 and interchanging of images based on Fade-in and Fade-out is processed in the mixer 53 of the M/E bank 250.

Because the key1 is selected as the transition target, if the transition is executed by pressing of the AutoTrans button or the manipulation of the fader lever, this becomes an operation in which image overlapping of the Key1 appears by the Fade-in. Next, if the transition is executed, the Fade-out is executed. An appearing image can be manipulated by selecting (pressing) the image by the key1 column of the cross point button.

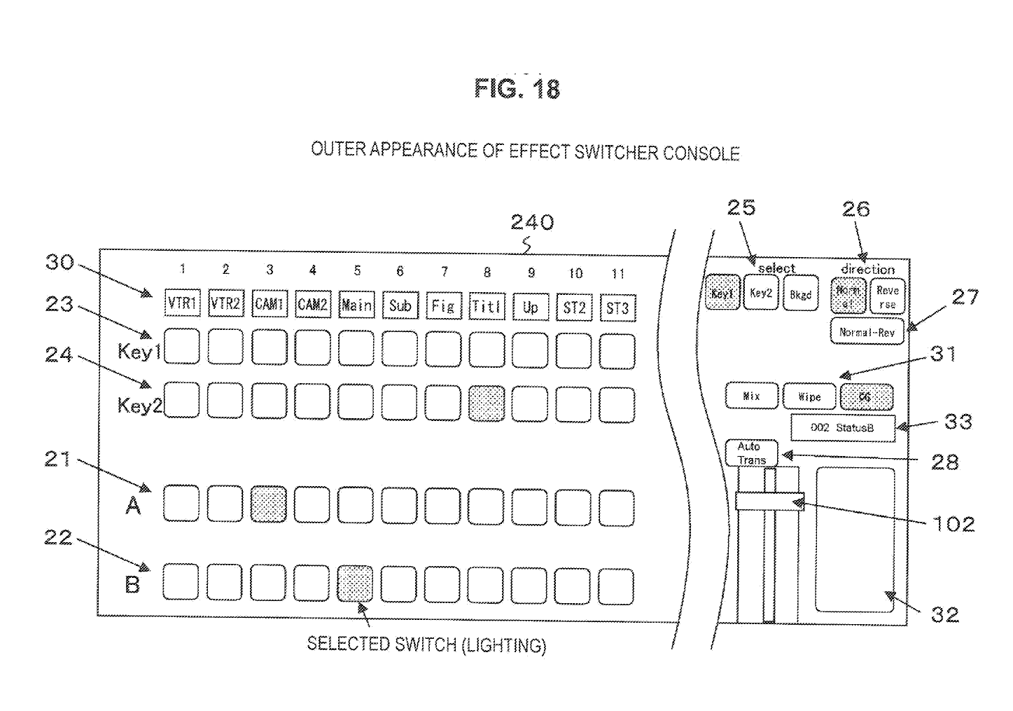

If the manipulator presses the CG button for the change from the Mix, the state becomes a (lightening) state illustrated in FIG. 18. In this state, in the input bus of the Key 1, an input signal from the image generating unit is selected by the cross point. In addition, control is performed such that image signal processing to overlap the image of the Key 1 as a front view is executed by the key image processing unit and the Mixer.

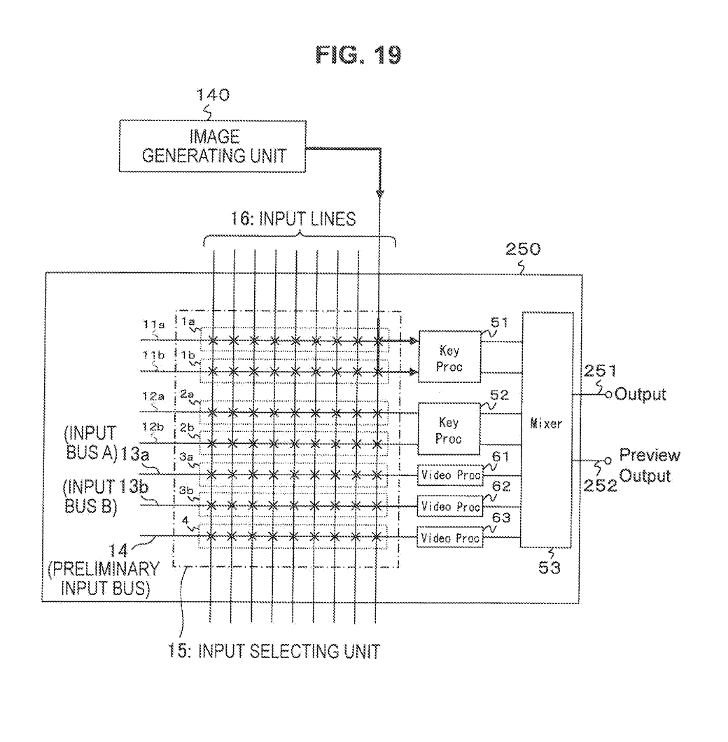

The overlapping is performed by determining pixels set as the front view by the key signal. As illustrated in FIG. 19, when the signal from the image generating unit 140 is taken in the key signal, overlapped pixels (density/α) are determined by key processing using a chroma key or brightness. As another example, content of the key signal may be generated by the image generating unit 140 at the same time as the CG image generation, one output line may be further provided, and the content of the key signal may be supplied to the key image processing unit through the cross point. In either case, the key signal processing and the overlapping processing are executed on the basis of the CG data.

In the state of FIG. 18, the image of the image generating unit 140 already overlaps the output image of the M/E bank 250. However, if the output image of the image generating unit 140 is in a state in which there is nothing in a screen, that is, a dark state in which there is not virtual light or reflection light by a virtual object, the output image does not overlap.

In the state of FIG. 18, the key1 column of the cross point button enters a state in which there is no button becoming the selected display (lightening). This shows that a signal other than a normal input signal is selected. When a button to select the input signal from the image generating unit 140 is allocated (assigned) to the cross point button, the button may be lightened by the Key 1 column of the cross point button. That is, this corresponds to the case in which a button corresponding to the tenth input line of FIG. 13 is assigned to the cross point button. The number of input signals of FIG. 13 is illustrated as 10 to simplify the illustration. However, the number of input signals is not limited to 10.

In order to select the status of the transition destination in the state of FIG. 18, the status is designated by a number by the ten key input unit 32. The number is assigned previously (sequentially) to each status. Alternatively, the state of the transition destination is selected from the screen illustrated in FIG. 16(B), by a GUI provided differently from FIG. 18. The selected transition destination status to be the transition destination instruction is displayed on the displayer. In FIG. 18, for example, “002 StatusB” is displayed.

If the transition is executed by pressing the automatic transition (AutoTrans) button 28 or manipulating the fader lever 102, the status of the image of the Key1 column transits from an original status of the image generating unit 140 to the instructed status, by the parameter interpolation. If the transition ends (AutoTrans completion/fader shaking), a different status can be selected as the transition destination and the transition to the different status can be executed.

In the operation by the automatic transition button 28, a fader value is controlled such that the transition progresses in a time of the transition stored previously in the memory (period storage unit) as the transition rate or the duration, by the progress rate control unit 160. The transition rate can be changed (written to the period storage unit) by a numerical value input unit (the ten key or the GUI).

In the transition by the fader lever 102, the progress rate becomes a value from 0% to 100% according to a manual manipulation and a CG image is generated by the parameter interpolated according to the progress rate. Because the lever manipulation is performed, an up and down manipulation may be performed. The control signal of the progress rate is transmitted from the switcher console 240 to the control unit 110.

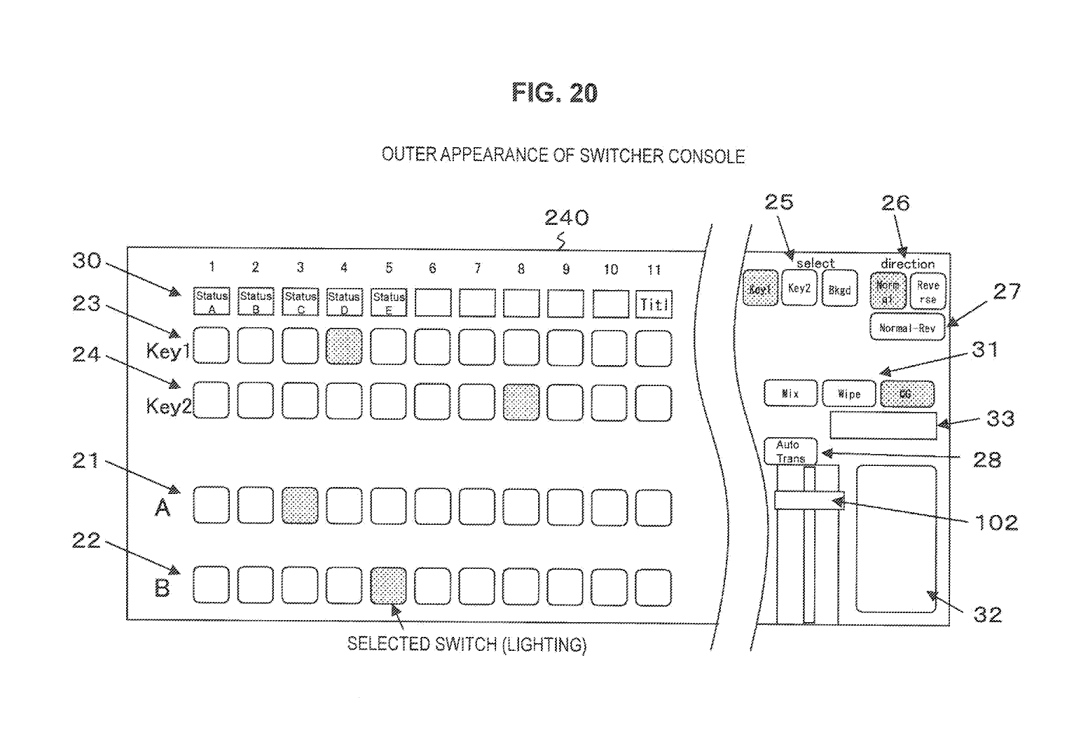

FIG. 20 illustrates a display example of the case of a configuration in which a transition destination instruction is performed by a manipulation of a cross point column, as another embodiment. In FIG. 18, the key1 column of the cross point button is extinguished. However, in FIG. 20, if the manipulator presses the CG button, the key1 column of the cross point button functions as a column of buttons corresponding to the statuses of the virtual space of the image generating unit 140.

Allocation content is displayed on a source name displayer 30 during pressing of the key1 button, if the key1 button is pressed. This display is illustrated in FIG. 20 and the buttons correspond to StatusA, StatusB, . . . from the left side. In FIG. 20, a button of StatusD is lightened and this shows a current status.

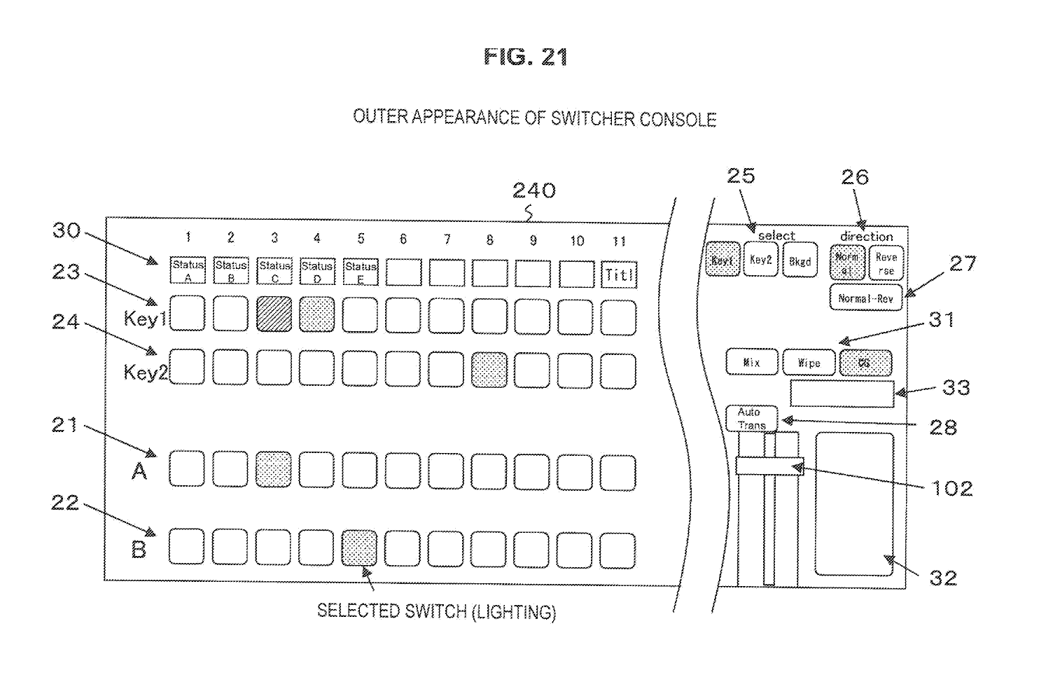

In order to manipulate and input the transition destination instruction for the transition from the current status, a button corresponding to a different status is pressed in the key1 column. For example, if a third button of StatusC is pressed, as illustrated in FIG. 21, the button is lightened with a different color (for example, a light color or flickering). Even though a button corresponding to a status that may not be selected is pressed, there is no reaction.

If the transition is executed by pressing the AutoTrans button or manipulating the fader lever 102, the status of the image of the Key1 column transits from an original status (StatusB) of the image generating unit 240 to an instructed status (StatusC), by the parameter interpolation. If the transition ends (AutoTrans completion/fader shaking), a selectable different status can be selected as the transition destination by the key1 column of the cross point button.

On the rightmost side of the source name displayer 30 in FIGS. 20 and 21, “Tit1” is displayed. “Tit1” shows a cross point that is selected by the Key1 column before switching the transition type (TransType) into the CG and remains as a choice of the Key1 column cross point button. If the “Tit1” is pressed by the Key1 column cross point button, the transition type returns from the CG to the original Mix, the function of the Key1 column cross point button returns to the original function, and the status returns to the status in which “Tit1” is selected. In this case, the example of the case in which only one choice remains in the function of the Key1 column cross point button is illustrated. However, in order to cause a plurality of choices to remain, function assigning with respect to the cross point button column may be set.

### [Texture Mapping]

In FIG. 13, the four image signals (T1, . . . , and T4) are supplied from the cross point to the image generating unit 140. These image signals become image signals that can be used for texture mapping in the CG image generation. In the image generating unit 140, by setting of the original CG data or the instruction by the manipulation, the input image signal is texture-mapped to the surface of the virtual object and an output image is generated. The four image signals are selected from the input image signals, by the cross point. However, the manipulation is performed by providing an Aux console (auxiliary console) in the switcher console 240.

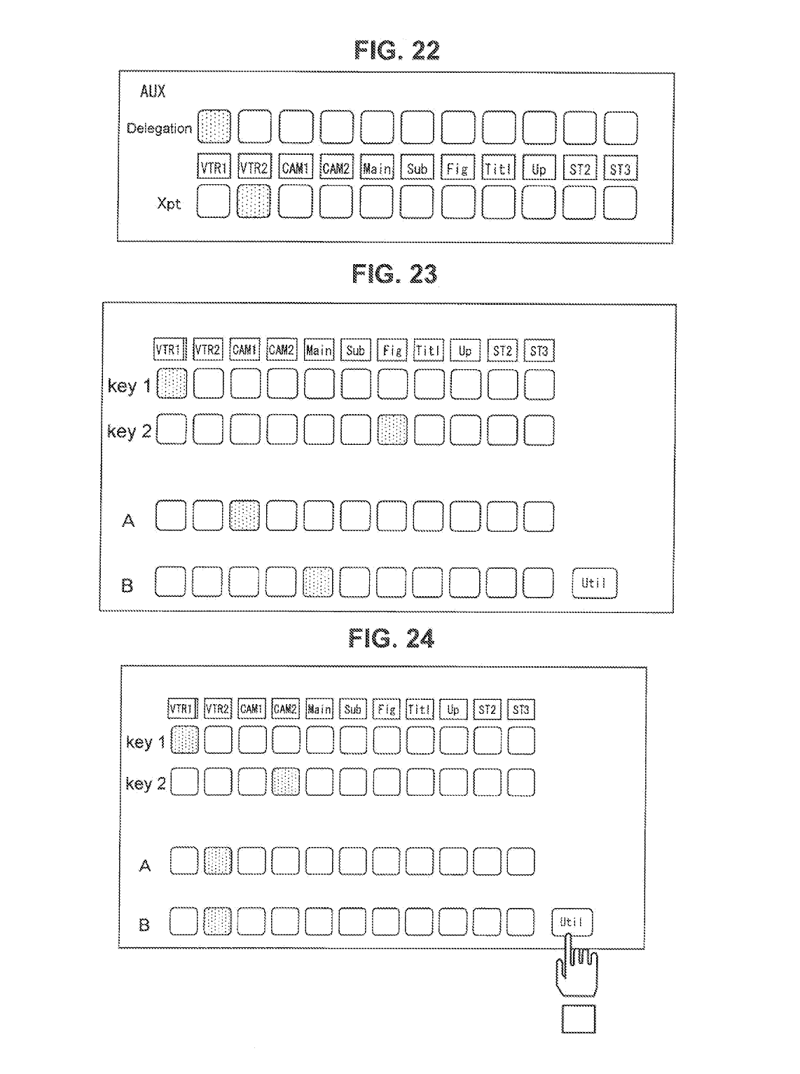

The manipulation target column is designated by a Delegation button in the Aux console illustrated in FIG. 22, a cross point button (Xpt) is manipulated, and any one signal is selected. Alternatively, as another example, selection of the four image signals is performed by the console of the M/E bank. That is, as an example different from the examples of FIGS. 19 and 20, the Key 1 column of the cross point button is made to function as a selection function of the four image signals of the texture mapping.

As illustrated in FIG. 23, an Util button is provided in the console of the M/E bank. If the manipulator presses the CG button, the Key 1 column cross point button becomes a button column that manipulates a cross point of Aux1 (T1). As illustrated in FIG. 23, when a first button is lightened, this means that a cross point of an input image signal allocated to the first button is selected.

In a state in which the CG button is lightened, manipulations of the cross points of Aux2, Aux3, and Aux4 buses can be performed by performing the display/manipulation while pressing the Util button. That is, in a state in which the Util button is continuously pressed, an A column becomes a button column to perform the manipulation of Aux2, a B column becomes a button column to perform the manipulation of Aux3, and a Key2 column becomes a button column to perform the manipulation of Aux4. In a state in which the Util button is continuously pressed, in the case of lightening of FIG. 24, an VTR1 signal is selected by the cross point in the Aux1, a VTR2 signal is selected by the cross point in the Aux2 and the Aux3, and a CAM2 signal is selected by the cross point in the Aux4 and the signals are supplied for the texture mapping.

Assigning of the input signal to the cross point button is stored by the following table. Numbers that are specially defined and are different from terminal numbers are assigned to internal signals and signals of circuit blocks are identified by the numbers. For example, an output of an image memory not illustrated in the drawings is selected.

Button number, external input/internal signal, input number, display name, external input, external input, external input, external input, external input, external input, external input, external input, external input, internal signal, internal signal
[Case of Timeline in which Passage is Defined]

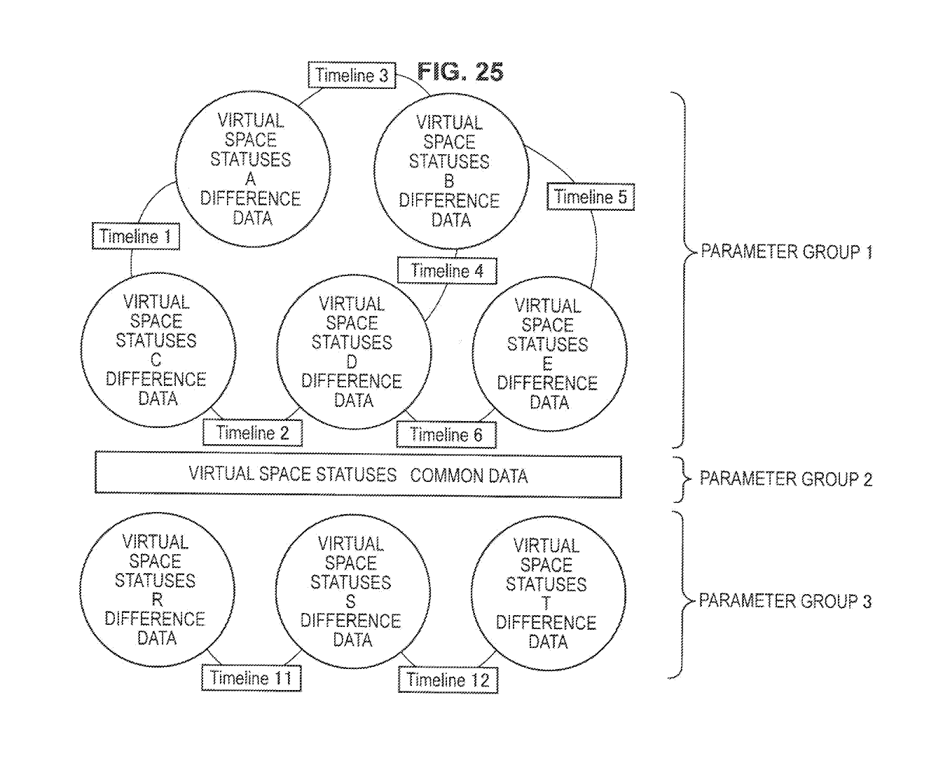

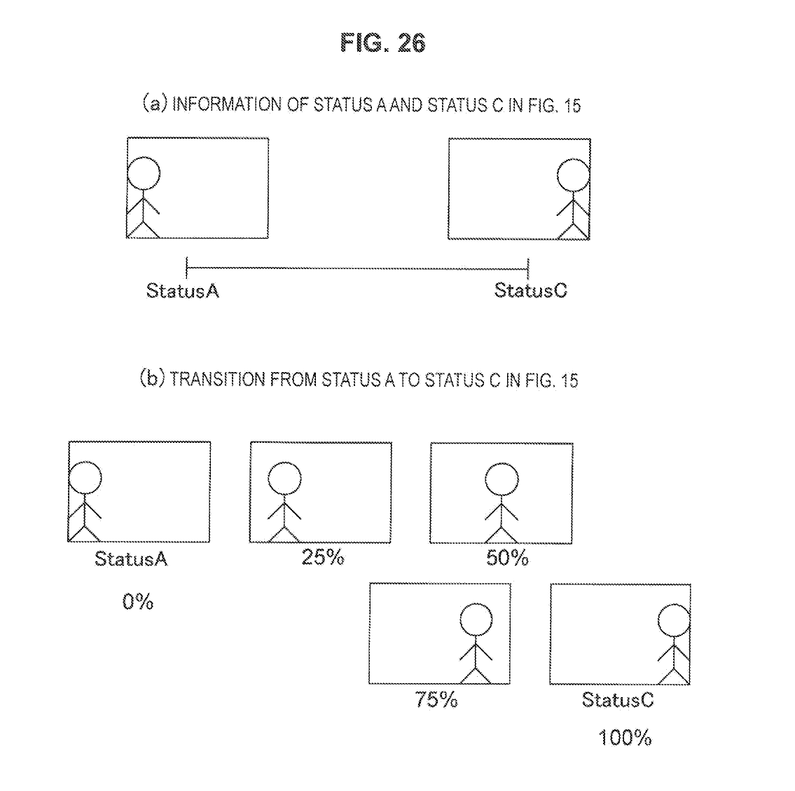

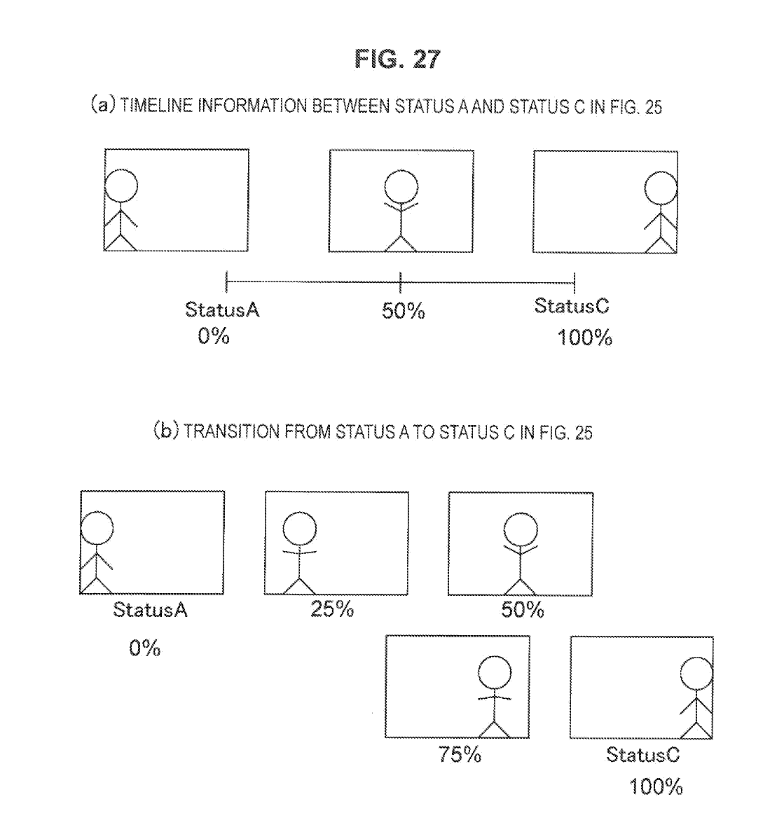

FIG. 25 illustrates a configuration of another example of complex data. In the example of the complex data of FIG. 15 described above, information regarding a transition operation does not exist in the side. In the example of the complex data of FIG. 25, information of the timeline is included in the side. In the example of FIG. 15, during the transition between statuses, the change of the CG is progressed by linearly interpolating the parameters between two points of both the states. For example, as illustrated in FIG. 26(a), information of the status A and the status C is included. As illustrated in FIG. 26(b), in the transition from the status A to the status C, the status A is set to 0%, the status C is set to 100%, the value of the parameter is linearly interpolated according to the change of the progress rate from 0% to 100%, and the transition is performed.

Meanwhile, in the example of FIG. 25, instead of the interpolation of both the states, the content of the change in the middle can be designated. As an example, information illustrated in FIG. 27(a) is stored in timeline1. The timeline1 has information in which the status A is set to 0%, the status C is set to 100%, the position becoming the key frame in the middle is designated by %, and the value of the parameter of the group 1 at that point of time is designated.

In this case, in the transition from the status A to the status C, the same manipulation (function) as the case of the example of FIG. 15 is performed. However, as illustrated in FIG. 27(b), a change of the image output during the transition becomes different. When the status A progresses to the status C or the status C progresses to the status A, even though the timeline1 is the same, a progress direction becomes reverse. Thereby, complicated transition is enabled and an added value of an output image is improved.

### [Non-Directed Graph and Directed Graph]

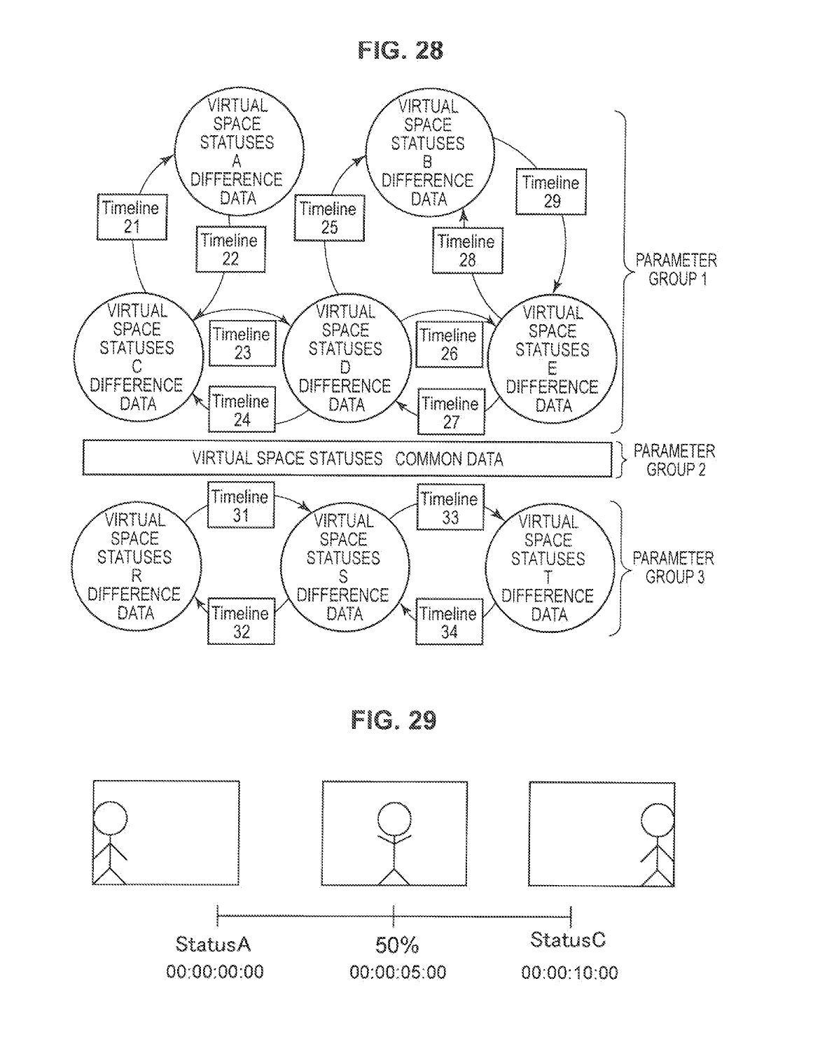

In the examples described above, the graph is the non-directed graph and if the transition from any status P to any status Q is enabled, the transition from the status Q to the status P is also enabled. Meanwhile, a configuration in which the complex data has the configuration of the directed graph and the transition of the reverse direction is disabled can be used. FIG. 28 illustrates a configuration example of complex data that has a valid graph structure.

In this configuration example, the transition from the status D to the status B is enabled. However, the transition from the status B to the status D is disabled. As content of an image in which the above configuration shows an effect, when a falling aspect of an object is set to the timeline, it is not preferable to progress the timeline in a reverse direction, because an unnatural image is generated. When this change is included, utilization of the directed graph increases an added value of an output image. FIG. 28 illustrates a configuration in which timeline information is included in the side of the directed graph. Different from the example of FIG. 25, each timeline of FIG. 28 does not reversely progress.

[Duration (Case of Timeline in which Length is Defined)]

The timeline illustrated in FIG. 27 does not include information of the length of the time and the position of the key frame is described by the progress rate % on the timeline. The timelines illustrated in FIGS. 25 and 26 may be configured as timelines having the length in a time unit, not %, as illustrated in FIG. 29. In this case, when the transition is executed, in the control of the progress rate, the following choices (1) to (3) exist.

In (1) and (2), information of the time assigned to the timeline is ignored and is only referred to as a ratio with respect to an entire portion. In this case, a different automatic transition (AutoTrans) button is provided as a manipulation unit to distinguish (1) and (3).

(1) Automatic Transition (AutoTrans) using Transition Rate set separately in advance
(2) Any Manual Manipulation using Fader Lever

### (3) Automatic Transition in Length of Time Unit of Timeline

### [Assigning of Coefficient to Duration]

In (3) described above, a value that is multiplied with the length of the timeline may be manipulated. For example, a coefficient can be manipulated by a rotation knob and designation can be performed to transit the status in a short time or a long time. The rotation knob may be manipulated in the middle of the transition and the transition may be accelerated or decelerated. That is, control may be performed such that a value of the knob is read at all times and a progress rate is increased or decreased. As a fader/curve function, the coefficient may be used as the function of the time unit or the progress rate. The fader/curve function can be applied to any one of (1) to (3), similar to the image effect according to the related art.

### [Editing Apparatus (Broader Concept)]

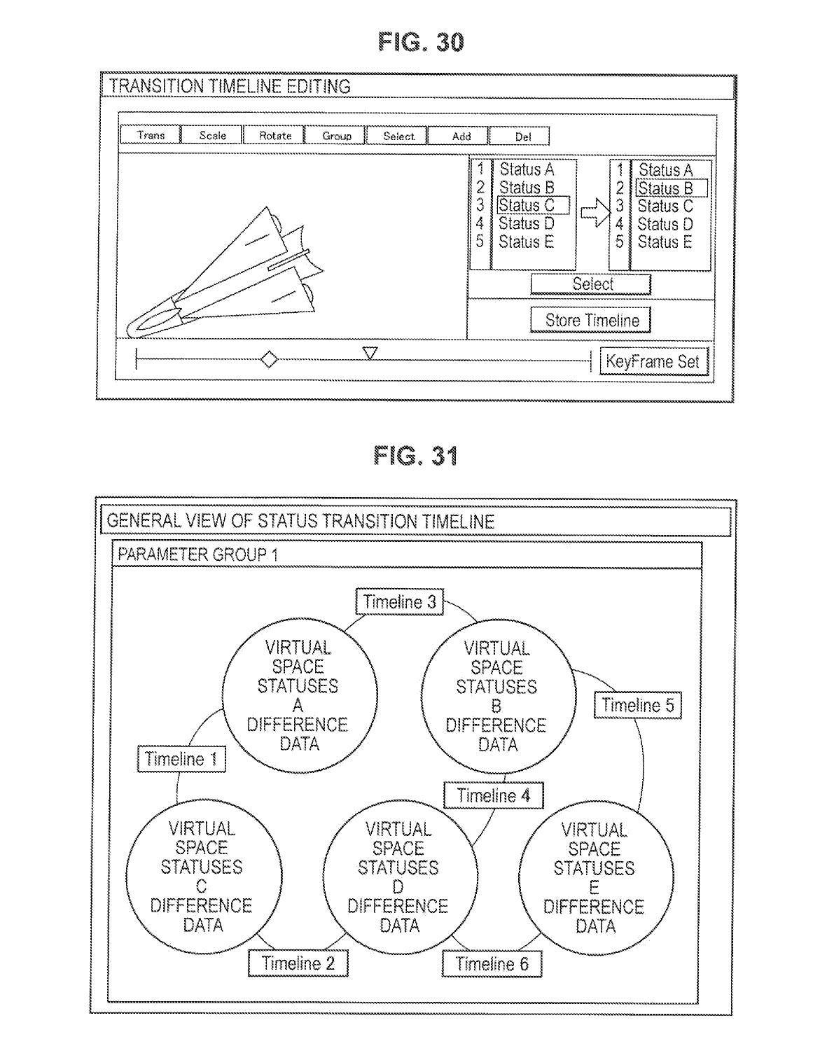

FIG. 30 illustrates a GUI of a function of editing a timeline at the time of transition between statuses. The GUI of FIG. 30 performs a function of selecting a status before the transition and a status after the transition and editing the timeline to generate the timeline of the side, in addition to the registration function of the status illustrated in FIG. 5.

In FIG. 30, an arrow that is rightward shows an editing screen with respect to the case in which the status transits from the left status to the right status. This is suitable for the complex data to be the directed graph. However, in the case of the complex data of the non-directed graph, setting the arrow direction to both directions becomes intuitive display. In a lower end of FIG. 30, the timeline is displayed. The leftmost side of the timeline is the status D to be status before the transition and the rightmost side of the timeline is the status B to be the status after the transition. The position on the timeline is designated (downward triangle) with respect to the in-progress data on the timeline, the status of the CG is edited by the CG display unit and the parameter manipulation function, and the status is registered as a key frame on the timeline, by a KeyFrame Set button. If the status is registered, the status is displayed with a diamond type

If the editing of the timeline ends, a Store Timeline button is pressed and the timeline is stored as a timeline of the transition from the status D to the status B in the complex data. With respect to an entire situation of the stored timeline, as illustrated in FIG. 31, a function displayed on the GUI as the status transition diagram like FIGS. 25 and 26 is provided to facilitate understanding of the situation. If a rectangle of each timeline of FIG. 31 is clicked, the screen may change to the editing screen of FIG. 30.

As another example, a structure of complex data can be held using a directory structure of a general-purpose file system, instead of a single file. By using this method, editing is easily performed by general CG editing software and a result is easily taken.

One file of a general CG timeline/animation holds one timeline. In the case of the complex data according to the present disclosure, the status progresses from one status to a plurality of timelines. For this reason, a method of collecting a plurality of files of which statuses of starting points of timelines are the same is necessary. Any attribute of the files in the file system may be used. For example, a method that stores the files in the same directory or shows the files by parts of file names is taken. This is applicable to an ending point.

An example of a method of showing (identifying) the starting point by the directory and showing the ending point by the part of the file name will be described. The file of the CG timeline/animation of the timeline that starts in the status A is stored in a directory StatusA. With respect to the other statuses B, C, D, and E, similarly, directories of StatusB, StatusC, StatusD, and StatusE are provided. A name of the file of the CG timeline/animation of the timeline that ends in the status B is set to XXX_To_StatusB.dae. However, a portion of XXX is any character string. With respect to the other statuses B, C, D, and E, the same naming is performed. In the case of the complex data of the non-directed graph, the file configuration in only one direction may be taken.

The summary is as follows. A starting end identifier is shown by the directory. That is, files having the same starting point identifiers are stored in the same directory. With respect to an ending point identifier, the identifier is marked for each file, with an attribute of a part of a name other than the directory.

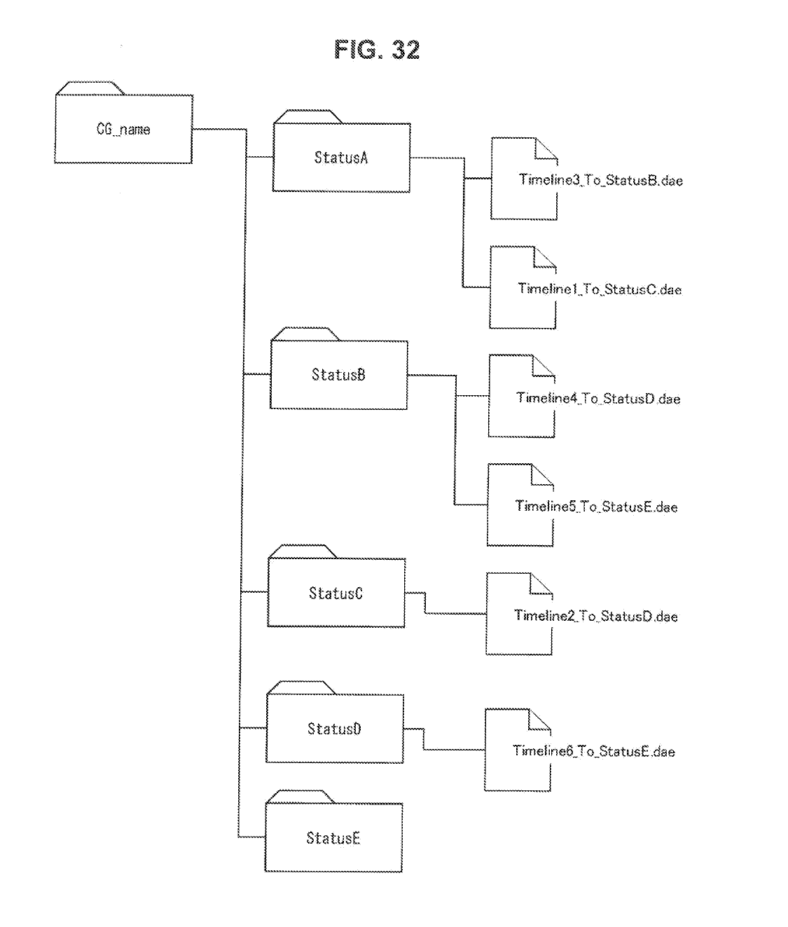

The structure of the timeline of the non-directed graph of FIG. 31 becomes equivalent to the configuration of the directory and the file name of FIG. 32. The file of each timeline is configured such that the starting point and the ending point do not change. The file can be edited by the normal CG editing software, has versatility, and is easily edited. In the case of the complex data of the directed graph, the file of the CG timeline/animation is installed for each direction.

### [Cross Point and Preview System]

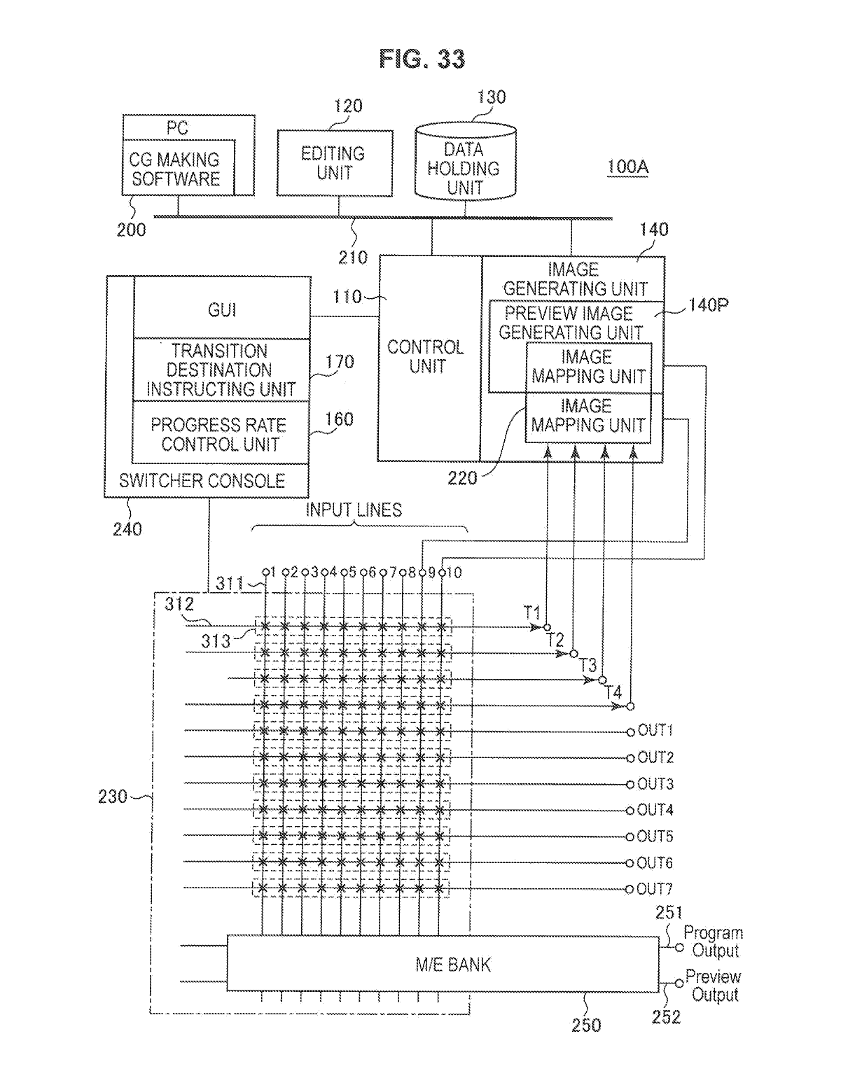

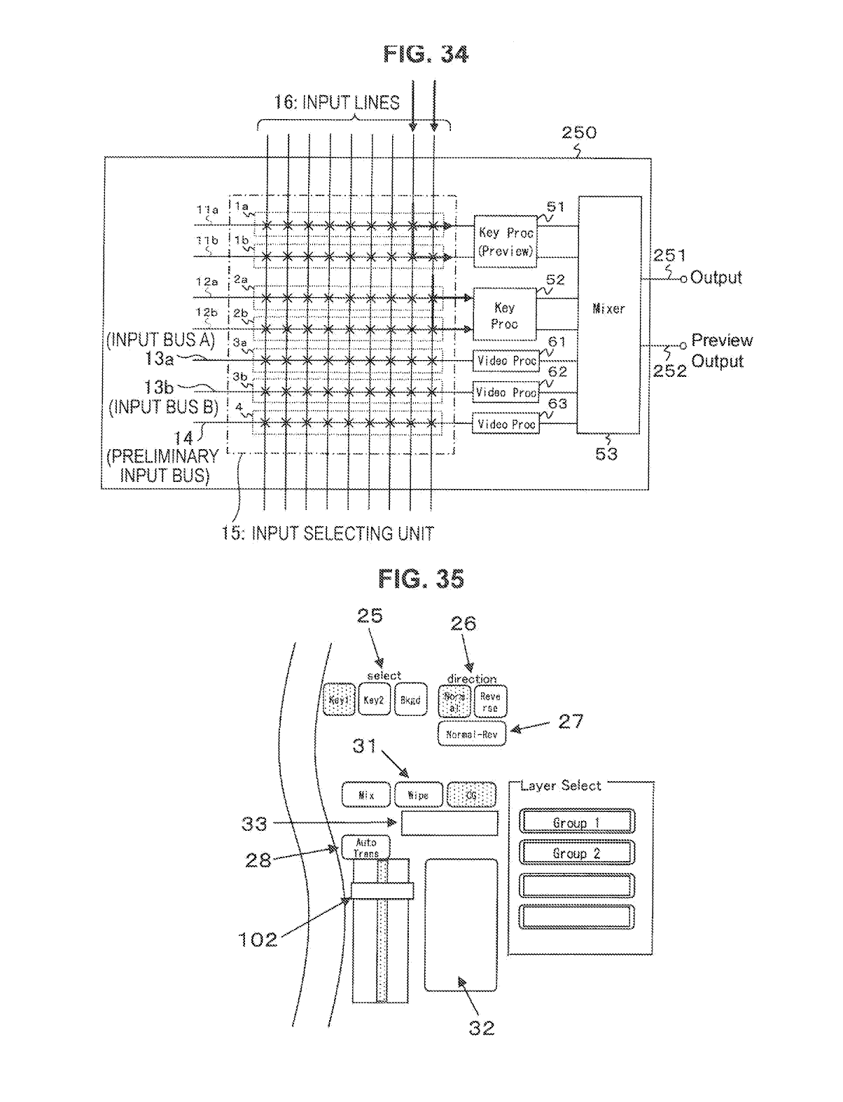

FIGS. 33 and 34 illustrate a system configuration in which a circuit block of a preview system is provided. In FIG. 33, in addition to the image generating unit 140, a preview image generating unit 140P is provided. If the control unit 110 receives a transition destination instruction, the preview image generating unit 140P performs image generation in a state of the transition destination and outputs an image.

The output is input as a preview CG image signal to a cross point of an effect switcher. In this case, an input to receive a preview system is provided in a cross point input. FIG. 34 illustrates the case in which a key image processing unit 51 for preview is provided in the M/E bank 250. A mixer 53 of FIG. 34 has a function of changing an image signal from the key image processing unit 51 for preview to an image signal from Key1 and outputting an overlapped image as a preview.

If the CG is instructed as a transition type (TransType), the image signal form the image generating unit 140 is selected in a cross point of an input bus of a Key1 column. At the same time, in a cross point of an input bus with respect to the key image processing unit for preview, the image signal from the preview image generating unit 140P is selected. The mixer 53 changes the image signal to the image signal from the Key1 and outputs an overlapped image of an image of a key system for preview to a preview output line 252.

Thereby, the operation manipulation can be performed while the change of the image after the transition is confirmed by a monitor. When the texture mapping is performed, the texture mapping may be performed with respect to a live image photographed by a camera. For this reason, it is difficult to previously grasp an actual aspect of content of the CG image in the output of the system. Therefore, this configuration shows an effect.

### [In Impossible Case, Fade-Out/Fade-In (Mix) by Mixer is Used]

In the explanation using FIG. 16, only the transition enabled states connected by the graph can be selected as the choice of the transition destination instructing unit 170 to manipulate and input the transition destination instruction. In the list box of Next of FIG. 16(b), a list of statuses in which the transition from the current status is enabled is displayed. The transition disabled statuses are not displayed. Meanwhile, as a modification of the present disclosure, the statuses in which the transition is disabled in the image generating unit 140, that is, the statuses not connected by the side of the graph may be displayed in the choices and a selection manipulation may be performed.

When the transition disabled statuses are selected and the transition execution is instructed, the status is transited from the image signal output by the key image processing unit of the Key1 to the image signal output by the key image processing unit for preview, by the function of a Mixer unit of the effect switcher. The transition becomes the transition that alternates the image by the Mix, that is, the Fade-in and the Fade-out. Alternatively, the transition may be realized in the same manner as the image switching using the normal wipe of the effect switcher, by a wipe function of the Mixer unit, not the Mix.

If the transition ends, switching is performed such that the image generating unit 140 generates an image in the status of the virtual space after the transition. Then, in the Mixer unit, the image processing unit is changed to the key image processing unit of the key system for preview and the image signal of the key image processing unit of the Key1 is overlapped again. At this time, the switching may be instant and does not affect the output image. Preferably, in the display of the choices, the display aspects may be slightly changed with respect to the transition disabled statuses (for example, colors are added or lamp lightening is added) to previously inform the manipulator of the execution of the transition by the function of the effect switcher.

### [Tarry]

In the effect switcher, there is a function of investigating an input signal (combined input image signal) included in a final output image and providing information thereof (identifier of the included input signal: number) as tarry information to the outside. In addition, there is a function of generating tarry information regarding a preview output in addition to tarry information regarding a current output (program output). In FIGS. 33 and 34, with respect to the program output, it is determined whether any image of images supplied for the texture mapping with respect to the image generating unit 140 is included in the output of the image generating unit 140 and the tarry information is generated.

In the configuration having the preview system with respect to the image generating unit 140 as illustrated in FIGS. 33 and 34, it is determined whether any image signal of image signals T1, . . . , and T4 for the texture mapping with respect to the preview image generating unit 140P is included in an output image (Preview Output), from the control state (image generation state) in the control unit 110, the status is combined with the status of the effect switcher, and information (tarry information) of the input image signal that is included in the preview output is generated. Thereby, in the operation using the image generating unit 140 in which the transition type is the CG, the tarry information of the preview output can be correctly generated and can be displayed on the displayer (the lamp or the GUI) and operability is improved.

### [Hierarchy/Group]

In the above description, the function of handling only the group 1 of FIG. 25 from the effect switcher has been described. As illustrated in FIG. 35, a button column may be provided as a Layer Select and a parameter group to manipulate the image transition may be selected after the transition type (TransType) is set to the CG.

If the selection of the group is changed, the choices and the display thereof are switched according to the group after the change. For example, the choices StatusA, StatusB, StatusC, StatusD, and StatusE are switched into the choices StatusR, StatusS, and StatusT. The parameter group in the virtual space that becomes the manipulation target can be designated. The selection of the parameter group using the button column can be manipulated at all times, regardless of the status of the currently manipulated parameter group.

### [Linked Transition]

As an application function, link setting may be performed, such that the status transition is performed with respect to other groups, when the status transition is performed by the manipulation with respect to the group selected by the group selection. Thereby, the status of the group can be linked with the statuses of other groups (values of other parameters in the CG). For example, when the link from the group 1 of FIG. 25 to the group 2 is set, the following table is stored.

Group 1, group 2

When the manipulation of the transition destination instruction is performed with respect to the group 1 according to the table and the transition is executed, the transition is executed simultaneously with respect to the group 2. Because the transition is disabled between the statuses not connected by the side of the graph structure like FIG. 25, considering (checking using a setting unit) is necessary when the link is set in the table, to prevent the side of the group 2 (slave side of the link) from receiving the transition destination instruction to be originally non-selectable by the link operation. Alternatively, as another embodiment, when the status in which the transition destination instruction is disabled is designated to the slave side, the salve side may progress to a different status by the function of the Mixer unit of the effect switcher, as described above.

[Execution of Operation Associated with Transition, According to Manipulation]

Preferably, a unit to input an instruction of an operation associated with the transition may be additionally provided in the console like FIG. 17. The associated operation is an operation while the transition progresses (when the progress rate is between 0% and 100%) and corresponds to changing of the parameters of the virtual space by the image generating unit 140 in the present disclosure.

The parameters that are changed by the associated operation are parameters other than the parameters (parameters of the corresponding group) normally changed by the transition and are preset as associated parameters (Modifiers). As an example of the associated operation, the case in which a value of a certain parameter changes only during the transition is considered. For example, an image effect in which a color of a certain portion becomes a different color only during the transition is obtained. By associatively operating the image effect by the independently provided manipulation input unit, selection that is executed at the time of the transition can be performed according to the intention of the manipulator.

Alternatively, as another example of the associated operation, a timeline operation of a target parameter may be performed. The timeline is not related to the transition and is independent. For example, the timeline has the following characteristics. That is, the target parameter has the same value at the starting point and the ending point and the timeline progresses according to the fader value (progress rate) of the transition (progresses in synchronization with the transition which is the main operation of an embodiment of the present disclosure). As a modification, the timeline may be a timeline where the same operation is repeated many times at the progress rate from 0% to 100%.

As an example of the image effect using the above configuration, a position of a slave screen of PinP (Picture in Picture) is prepared as a status, an image in which the slave screen is moved by the transition is obtained, a timeline in which a frame of the slave screen changes is prepared as the associated operation, and the movement of the slave screen can be associated with the change of the frame according to the intention of the manipulator at the time of the manipulation. Thereby, a different impression can be given to a viewer in the movement of the same slave screen in the generated image, according to whether the associated operation exists.

### [Restriction of Transition by Condition]

Preferably, the transition can be restricted such that the status does not transit to a partial status, by an external signal received from the I/F unit 180 or the status of the effect switcher. The corresponding status is not displayed or is not selected as the choice of the transition destination instruction.

### [Thumbnail for Manipulation]

As the display of the choice of the transition destination instruction (the GUI or the displayer adjacent to the button column), a change image of the output image of the effect switcher after the transition may be reduced and displayed. Thereby, the operability is improved. In this case, a previously rendered still image may be displayed, the image generating unit may be provided and the rendered image may be displayed at all times, or one image generating unit may be used for rendering of a different status with time division for each frame and an occasionally updated image may be displayed.

In the examples described above, the output of the image generating unit 140 is selected by the cross point by the selection manipulation of the transition type (TransType). However, as another example, a method of selecting an output of the image generating unit 140 in the manipulation of the cross point button column can be adopted. If the output of the mage generating unit is selected in the cross point button column, assigning may be changed and the transition destination may be selected and instructed in the cross point button column.

When (the CG units such as) the plurality of image generating units are used from the effect switcher, the console of the effect switcher can be configured such that the transition destination instruction manipulation can be performed with respect to one of the plurality of image generating units selected by the transition type (TransType) or the cross point button column.

### 3. Modification

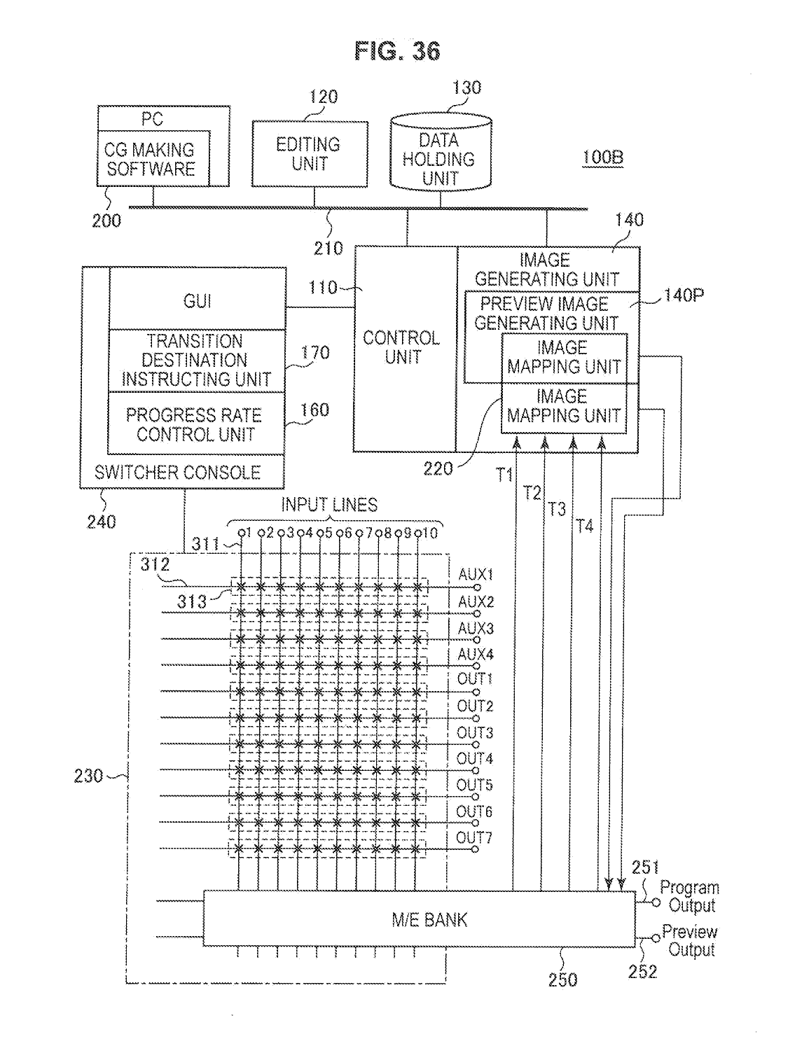

FIG. 36 illustrates a configuration example of an image processing apparatus 100B in the case in which an M/E bank 250 of an effect switcher and an image generating unit 140 are connected without using a cross point. In FIG. 36, portions corresponding to FIG. 13 are denoted with the same reference numerals. In the case of this configuration, it is not necessary to set an image signal between the image generating unit 140 and the M/E bank 250 as an SDI signal. For example, a configuration using a bus line between substrates is enabled. Image signals T1, . . . , and T4 that are supplied for the texture mapping can be configured to be selected by a cross point of a bus to supply signals to the M/E bank 250.

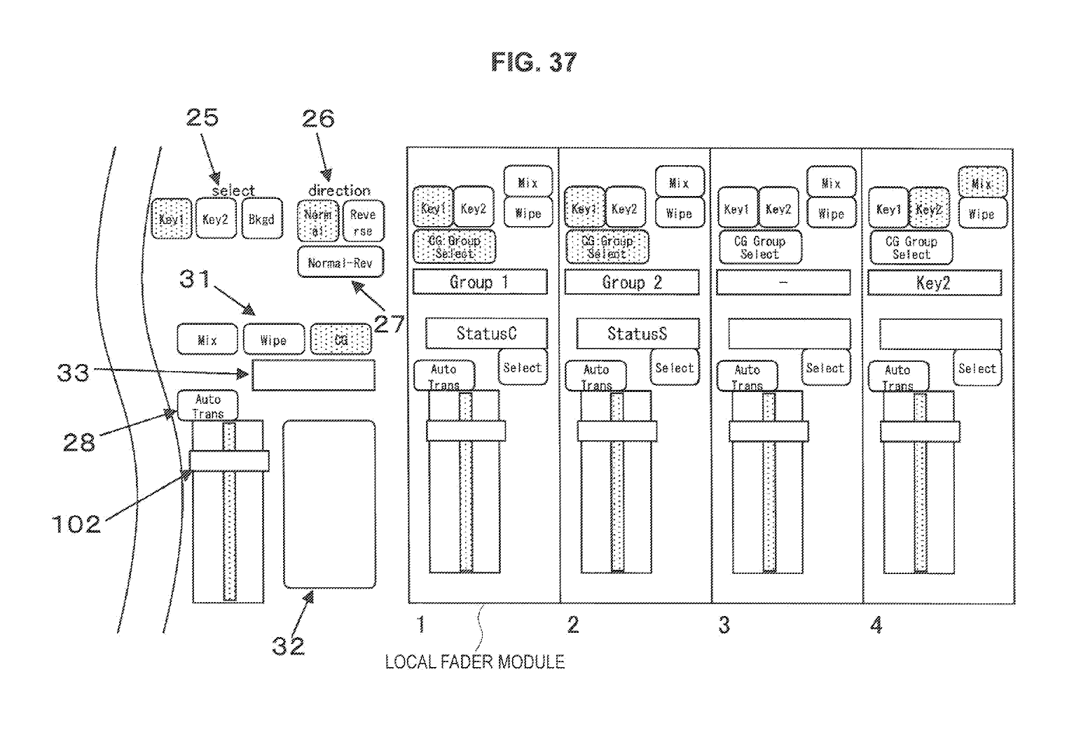

FIG. 37 illustrates a configuration example of a console that can manipulate groups in parallel. A local fader module performs a fader manipulation with respect to one of parameter groups of the CG or a fader manipulation with respect to one keyer. A plurality of local fader modules are provided and can be manipulated in parallel. In FIG. 37, four local fader modules are illustrated. The function of the local fader modules may be realized by the GUI.

Key1 and Key2 buttons of FIG. 37 are two-choice buttons to select to set any keyer as a manipulation target. In a CG Group Select button, display of parameter groups of a displayer below the CG Group Select button is switched whenever the CG Group Select button is pressed. The CG Group Select button can select one or none in the plurality of parameter groups set as the manipulation targets of the module (manipulating the Key1 or the Key2, regardless of the image generating unit 140). When the parameter group is selected, the keyer selected by any one of the Key1 button and the Key2 button is operated by receiving the output of the image generating unit 140. A Select button is a unit (transition destination instruction manipulation unit) to select the status (StatusC) of the transition destination. Whenever the Select button is pressed, the selection of the status that becomes the transition destination of the group is switched and display is switched.

Alternatively, the choice of the transition destination may be displayed on the GUI unit by pressing. In “4” of FIG. 37, the Key2 is selected and this becomes a status in which the Key2 of the effect switcher is controlled, regardless of the CG In “3” of FIG. 37, the manipulation target is not allocated to the Key1 and the Key2. Therefore, even though the manipulation is performed, this becomes invalid.

### [Link to Other Operation of Effect Switcher]

A link function may be mounted to operate a preset function of the effect switcher according to an operation of the transition to a certain status or an operation of the transition from the certain status. With respect to a targeted status, a function of performing selection setting is provided in the GUI. As the setting function, a function of switching a cross point of the bus like out1 of FIG. 13 to the set input or a function of switching On/Off of the set keyer can be performed. Alternatively, if a value of a certain parameter in the virtual space is within a certain range, the preset function of the effect switcher may be operated.

### [Control of Apparatus According to Value of Parameter in Virtual Space]

An external apparatus may be controlled according to a value of a parameter in the virtual space that is changed by the transition. Because the parameter in the virtual space is changed due to various factors such as the animation or the manual manipulation in addition to the transition to be the characteristic of the present disclosure, the external apparatus is controlled by the changed value of the parameter, so that linking can be performed without depending on the change factors.

As an example, using a ratio of a specific architecture in a frame of an output image as a control source, a level of a certain line of a preset audio mixer is controlled. As another example, using a value of a color of a certain material as a control source, a level of a certain line of a preset audio mixer is controlled. Thereby, a color or brightness and a volume can be linked. As another example, a level of a certain line of a preset audio mixer is controlled by the position coordinates of a virtual object. Thereby, an actual volume can be controlled by a fader lever of the CG.

As another example, using a direction of a virtual camera as a control source, a robot camera (camera platform driven by a motor) is controlled. Alternatively, using a movement of a knob in the virtual space as a control source, the robot camera is controlled. As another example, a play time code of an external video server may be controlled by the position coordinates of the virtual object. If an output of the video server is texture-mapped in the virtual space, a video image that is texture-mapped according to the change in the virtual space can be changed. As another example, brightness of illumination may be controlled in a place where an output image is displayed to the public.

As such, various changes are caused by a manipulation with extemporaneousness and a video/audio output having a high added value can be obtained.

### [Data XML Sample of Graph Structure]

Hereinafter, an example of data of a graph structure described with a simple schema as a realization method will be described.

### Example Corresponding to “Non-Directed Graph of FIG. 15”:

<transition_edges>

<ss_edgeid=“trans_edge_01”>

<diff_ref url=“#StatusA”>
<diff_ref url=“#StatusC”>

</ss_edge>
<ss_edge id=“trans_edge_02”>

<diff_ref url=“#StatusB”>
<diff_ref url=“#StatusD”>

</ss_edge>
•••
</transition_edges>

### Example Corresponding to “Directed Graph and Timeline of FIG. 26”:

<ss_transitions>
<ss_transition id=“trans21” start=“#StatusC”end=“#StatusA”>

•••(data of timeline)

</ss_transition>
<ss_transition id=“trans22” start=“#StatusA”end=“#StatusC”>

•••(data of timeline)

</ss_transition>

•••

</ss_transitions>

With respect to the details of a method of describing data of a timeline, content in the specifications of the Collada can be used.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing apparatus including:

an image generating unit that generates an image by performing image combining by computer graphics, based on complex data which is description data of a virtual space by the computer graphics and which has a plurality of static statuses of the virtual space;

a video output unit that outputs the generated image as a video signal; and

a control unit that causes the image generating unit to perform the image combining while performing transition according to a progress rate from a first static status to a second static status, based on an instruction of transition from the first static status to the second static status in the complex data.

(2) The image processing apparatus according to (1),

wherein the image generating unit generates the image by performing the image combining by the computer graphics, on the basis of the complex data which is the description data of the virtual space by the computer graphics and which has a graph structure in which the plurality of static statuses of the virtual space are arranged on nodes of the graph structure and the nodes are connected by sides of the graph structure, and

the control unit causes the image generating unit to perform the image combining while performing the transition according to the progress rate from the first static status to the second static status, based on the instruction of the transition from the first static status to the second static status connected by the sides in the complex data.

(3) The image processing apparatus according to (2),

wherein a data structure in which lengths of times are held in the sides of the complex data of the graph structure is configured, and

wherein the control unit uses the lengths of the times of the sides, when the transition of the sides is executed.

(4) The image processing apparatus according to (2),

wherein a data structure, in which data of statuses between the nodes and data of relative periods or absolute periods during the transition of the sides are held in the sides of the complex data of the graph structure, is configured, and

wherein the control unit interpolates the statuses held in the sides according to the periods during the transition corresponding to the statuses, when the transition of the sides is executed.

(5) The image processing apparatus according to any one of (1) to (4),

wherein the control unit changes values of parameters forming the statuses of the virtual space, according to the progress rate, for each synchronization signal supplied from the outside.

(6) The image processing apparatus according to (1),

wherein the control unit changes the progress rate according to an elapsed time from a start of the instruction of the transition.

(7) The image processing apparatus according to (1),

wherein the control unit changes the progress rate according to a fader value from a fader.

(8) The image processing apparatus according to any one of (1) to (7),

wherein the instruction of the transition is based on a control signal from the outside.

(9) The image processing apparatus according to any one of (1) to (8),

wherein the control unit restricts, by a condition, the transition based on the instruction of the transition.

(10) The image processing apparatus according to any one of (1) to (9),

wherein the complex data has a plurality of statuses for each of groups obtained by dividing parameters of the virtual space.

(11) The image processing apparatus according to any one of (1) to (10), further including:

an effect switcher;

a selection manipulation unit that receives a manipulation for selecting an input signal supplied to a bus in the effect switcher from a plurality of choices and transmits a control signal to the effect switcher; and

an allocating unit that sets content of each choice of the selection manipulation unit,

wherein the video signal output from the video output unit is one of input signals of the effect switcher, and

wherein the allocating unit transmits a transition destination instruction to the control unit, in addition to the setting of the content of each choice of the selection manipulation unit.

(12) The image processing apparatus according to (11),

wherein a transition trigger manipulation unit that manipulates the transition by a wipe function of the effect switcher is made to function as a manipulation unit to generate a trigger to start the transition of the image generating unit and

wherein the progress rate of the transition is manipulatable by a fader lever.

(13) The image processing apparatus according to (11) or (12), further including:

a preview image generating unit that generates an image for preview by performing the image combining by the computer graphics; and

a preview video output unit that outputs the generated image for preview as a video signal,

wherein the effect switcher has a preview system that outputs a video signal scheduled for a next effect switcher output, and

the effect switcher causes the preview image generating unit to generate an image at the time of transition completion, according to a transition manipulation of the selection manipulation unit, causes the preview video output unit to output the video signal of the image for the preview, and causes the preview system of the effect switcher to output the video signal.

(14) An image processing method including:

generating an image by performing image combining by computer graphics, based on complex data which is description data of a virtual space by the computer graphics and which has a plurality of static statuses of the virtual space;

outputting the generated image as a video signal; and

performing the image combining while performing transition according to a progress rate from a first static status to a second static status, based on an instruction of transition from the first static status to the second static status in the complex data.

(15) A program for causing a computer to function as:

an image generating unit that generates an image by performing image combining by computer graphics, based on complex data which is description data of a virtual space by the computer graphics and which has a plurality of static statuses of the virtual space;

a video output unit that outputs the generated image as a video signal; and

a control unit that causes the image generating unit to perform the image combining while performing transition according to a progress rate from a first static status to a second static status, on the basis of an instruction of transition from the first static status to the second static status in the complex data.

The present disclosure contains subject matter related to that disclosed in Japanese Priority Patent Application JP 2012-221740 filed in the Japan Patent Office on Oct. 3, 2012, the entire content of which is hereby incorporated by reference.

What is claimed is:

1. An image processing apparatus comprising:
an image generating unit that generates an image by performing image combining by computer graphics, based on complex data which is description data of a virtual space by the computer graphics and which has a plurality of static statuses of the virtual space;
a video output unit that outputs the generated image as a video signal; and
a control unit that causes the image generating unit to perform the image combining while performing transition according to a progress rate from a first static status to a second static status, based on an instruction of transition from the first static status to the second static status in the complex data.

2. The image processing apparatus according to claim 1,
wherein the image generating unit generates the image by performing the image combining by the computer graphics, on the basis of the complex data which is the description data of the virtual space by the computer graphics and which has a graph structure in which the plurality of static statuses of the virtual space are arranged on nodes of the graph structure and the nodes are connected by sides of the graph structure, and
the control unit causes the image generating unit to perform the image combining while performing the transition according to the progress rate from the first static status to the second static status, based on the instruction of the transition from the first static status to the second static status connected by the sides in the complex data.

3. The image processing apparatus according to claim 2,
wherein a data structure in which lengths of times are held in the sides of the complex data of the graph structure is configured, and
wherein the control unit uses the lengths of the times of the sides, when the transition of the sides is executed.

4. The image processing apparatus according to claim 2,
wherein a data structure, in which data of statuses between the nodes and data of relative periods or absolute periods during the transition of the sides are held in the sides of the complex data of the graph structure, is configured, and
wherein the control unit interpolates the statuses held in the sides according to the periods during the transition corresponding to the statuses, when the transition of the sides is executed.

5. The image processing apparatus according to claim 1,
wherein the control unit changes values of parameters forming the statuses of the virtual space, according to the progress rate, for each synchronization signal supplied from the outside.

6. The image processing apparatus according to claim 1,
wherein the control unit changes the progress rate according to an elapsed time from a start of the instruction of the transition.

7. The image processing apparatus according to claim 1,
wherein the control unit changes the progress rate according to a fader value from a fader.

8. The image processing apparatus according to claim 1,
wherein the instruction of the transition is based on a control signal from the outside.

9. The image processing apparatus according to claim 1,
wherein the control unit restricts, by a condition, the transition based on the instruction of the transition.

10. The image processing apparatus according to claim 1,
wherein the complex data has a plurality of statuses for each of groups obtained by dividing parameters of the virtual space.

11. The image processing apparatus according to claim 1, further comprising:
an effect switcher;
a selection manipulation unit that receives a manipulation for selecting an input signal supplied to a bus in the effect switcher from a plurality of choices and transmits a control signal to the effect switcher; and
an allocating unit that sets content of each choice of the selection manipulation unit,
wherein the video signal output from the video output unit is one of input signals of the effect switcher, and
wherein the allocating unit transmits a transition destination instruction to the control unit, in addition to the setting of the content of each choice of the selection manipulation unit.

12. The image processing apparatus according to claim 11,
wherein a transition trigger manipulation unit that manipulates the transition by a wipe function of the effect switcher is made to function as a manipulation unit to generate a trigger to start the transition of the image generating unit and
wherein the progress rate of the transition is manipulatable by a fader lever.

13. The image processing apparatus according to claim 11, further comprising:
a preview image generating unit that generates an image for preview by performing the image combining by the computer graphics; and
a preview video output unit that outputs the generated image for preview as a video signal,
wherein the effect switcher has a preview system that outputs a video signal scheduled for a next effect switcher output, and
the effect switcher causes the preview image generating unit to generate an image at the time of transition completion, according to a transition manipulation of the selection manipulation unit, causes the preview video output unit to output the video signal of the image for the preview, and causes the preview system of the effect switcher to output the video signal.

14. An image processing method comprising:
generating an image by performing image combining by computer graphics, based on complex data which is description data of a virtual space by the computer graphics and which has a plurality of static statuses of the virtual space;
outputting the generated image as a video signal; and
performing the image combining while performing transition according to a progress rate from a first static status to a second static status, based on an instruction of transition from the first static status to the second static status in the complex data.

15. A program for causing a computer to function as:
an image generating unit that generates an image by performing image combining by computer graphics, based on complex data which is description data of a virtual space by the computer graphics and which has a plurality of static statuses of the virtual space;
a video output unit that outputs the generated image as a video signal; and
a control unit that causes the image generating unit to perform the image combining while performing transition according to a progress rate from a first static status to a second static status, on the basis of an instruction of transition from the first static status to the second static status in the complex data.
